(19) United States
(12) Patent Application Publication
(10) Pub. No.: US 2026/0205583 A1
(43) Pub. Date: Jul. 16, 2026

(54) METHOD AND APPARATUS FOR ENCODING IMAGE BY USING FILTERED OPTICAL FLOW, AND METHOD AND APPARATUS FOR DECODING IMAGE

(71) Applicant: SAMSUNG ELECTRONICS CO., LTD., Suwon-si (KR)

(72) Inventors: Quockhanh DINH, Suwon-si (KR); Kwangpyo CHOI, Suwon-si (KR)

(73) Assignee: SAMSUNG ELECTRONICS CO., LTD., Suwon-si (KR)

(21) Appl. No.: 19/564,657

(22) Filed: Mar. 12, 2026

Related U.S. Application Data
(63) Continuation of application No. PCT/KR2024/010565, filed on Jul. 22, 2024.

(30) Foreign Application Priority Data
Sep. 13, 2023 (KR) 10-2023-0122068
Dec. 14, 2023 (KR) 10-2023-0182371

(51) Int. Cl. H04N 19/117; H04N 19/136; H04N 19/172; H04N 19/42

(52) U.S. Cl. CPC H04N 19/117; H04N 19/136; H04N 19/172; H04N 19/42

(57) ABSTRACT

An image decoding method including obtaining, from a bitstream, feature data of a preliminary optical flow and filtering information, the filtering information including at least one of type information of a filter or parameter information of a filter. The method including obtaining the preliminary optical flow by applying the feature data of the preliminary optical flow to a neural network based first decoder. The method including generating an optical flow by applying the preliminary optical flow to a filter corresponding to the filtering information. The method including generating a current reconstructed image by using previous data and the optical flow.

### CROSS-REFERENCE TO RELATED APPLICATIONS

This application is a continuation of International Application No. PCT/KR2024/010565, filed on Jul. 22, 2024, which is based on and claims priority to Korean Provisional Patent Application No. 10-2023-0122068, filed on Sep. 13, 2023, in the Korean Intellectual Property Office, and Korean Patent Application No. 10-2023-0182371, filed on Dec. 14, 2023, in the Korean Intellectual Property Office, the disclosures of which are incorporated by reference herein in their entireties.

### BACKGROUND

### 1. Field

The present disclosure relates to encoding and decoding of images. Particularly, the present disclosure relates to technologies for encoding and decoding images by using artificial intelligence (AI), for example, a neural network.

### 2. Description of Related Art

In codecs, such as, H.264 advanced video coding (AVC) and high efficiency video coding (HEVC), an image may be divided into blocks, and each block may be prediction-encoded and prediction-decoded through inter prediction or intra prediction.

Intra prediction is a method of compressing an image by removing spatial redundancy within the image, and inter prediction is a method of compressing an image by removing temporal redundancy between images.

An example of inter prediction is motion estimation coding. The motion estimation coding predicts blocks of a current image using a reference image. A reference block most similar to the current block may be searched for within a predetermined range in the reference image by using a predetermined evaluation function. The current block is predicted based on the reference block, and a resulting predicted block is subtracted from the current block to generate and encode a residual block.

The background technology described above is technical information that the inventor possessed for deriving the disclosure or acquired in the process of deriving the disclosure and therefore cannot necessarily be considered as prior art publicly disclosed before the filing of the disclosure.

### SUMMARY

According to an embodiment of the present disclosure, an image decoding method including: obtaining, from a bitstream, feature data of a preliminary optical flow and filtering information, the filtering information including at least one of type information of a filter or parameter information of a filter; obtaining the preliminary optical flow by applying the feature data of the preliminary optical flow to a neural network based first decoder; generating an optical flow by applying the preliminary optical flow to a filter corresponding to the filtering information; and generating a current reconstructed image by using previous data and the optical flow.

In an embodiment, the image decoding method further includes obtaining feature data of a residual image from the bitstream, and the generating of the current reconstructed image includes obtaining the current reconstructed image by applying the optical flow, the feature data of the residual image, and the previous data to a neural network based second decoder.

In an embodiment, the method includes obtaining feature data of a residual image from the bitstream. The generating of the current reconstructed image includes: obtaining the residual image by applying the feature data of the residual image to a neural network based second decoder; generating a prediction image from the previous data based on the optical flow; and generating the current reconstructed image by combining the prediction image and the residual image.

In an embodiment, the filtering information further includes weight information, and the generating of the optical flow including: generating a filtered preliminary optical flow by applying the preliminary optical flow to a filter corresponding to the filtering information; and generating the optical flow by combining the preliminary optical flow and the filtered preliminary optical flow according to the weight information.

In an embodiment, the filtering information further includes weight information, and the generating of the optical flow includes: generating a first filtered preliminary optical flow by applying the preliminary optical flow to a first filter indicated by the type information; generating a second filtered preliminary optical flow by applying the preliminary optical flow to a second filter indicated by the type information; and generating the optical flow by combining the first filtered preliminary optical flow and the second filtered preliminary optical flow according to the weight information.

In an embodiment, the type information of the filter indicates at least one of a Gaussian filter, a median filter, a bilateral filter, or a neural network filter.

In an embodiment, when the type information of the filter indicates the neural network filter, the parameter information indicates a neural network among a plurality of neural networks of different types, and the generating of the optical flow includes: obtaining the optical flow by applying the preliminary optical flow to the neural network indicated by the parameter information.

According to an embodiment of the present disclosure, an image encoding method including: obtaining feature data of a preliminary optical flow by applying a current image and previous data to a neural network based first encoder; obtaining the preliminary optical flow by applying the feature data of the preliminary optical flow to a neural network based first decoder; selecting a filter used for filtering the preliminary optical flow from among a plurality of filters; generating an optical flow by applying the preliminary optical flow to the filter; encoding the current image by using the optical flow and the previous data; and generating a bitstream including the feature data of the preliminary optical flow and filtering information for the filter. The filtering information includes at least one of type information of the filter or parameter information of the filter.

In an embodiment, the encoding of the current image includes: obtaining feature data of a residual image by applying the current image, the previous data, and the optical flow to a neural network based second encoder. The feature data of the residual image is included in the bitstream.

In an embodiment, the encoding of the current image includes: generating a prediction image from the previous data based on the optical flow; and obtaining the feature data of the residual image by applying the residual image corresponding to a difference between the prediction image and the current image to the neural network based second encoder. The feature data of the residual image is included in the bitstream.

In an embodiment, the selecting of the filter includes: generating a plurality of optical flows by applying the preliminary optical flow to the plurality of filters; and selecting at least one filter from among the plurality of filters based on a difference between each of a plurality of prediction images generated based on each of the plurality of optical flows and the current image.

In an embodiment, the selecting of the filter includes: selecting at least one filter from among the plurality of filters based on at least one of: a difference between each of a plurality of current reconstructed images which are generated in response to each of the plurality of filters and the current image, or a comparison result of bitrates of bitstreams which are generated in response to each of the plurality of filters.

In an embodiment, the plurality of filters include neural network filters that use different types of neural networks, the neural networks used in the neural network filters output a training optical flow by processing a training preliminary optical flow, and the neural networks are trained based on a comparison result between the training optical flow and a ground truth optical flow.

According to an embodiment of the present disclosure, a non-transitory computer-readable recording medium having recorded thereon instructions executable by at least one processor to cause the at least one processor to perform a method including: obtaining feature data of a preliminary optical flow by applying a current image and previous data to a neural network based first encoder; obtaining the preliminary optical flow by applying the feature data of the preliminary optical flow to a neural network based first decoder; selecting a filter used for filtering the preliminary optical flow from among a plurality of filters; generating an optical flow by applying the preliminary optical flow to the filter; encoding the current image by using the optical flow and the previous data; and generating a bitstream including the feature data of the preliminary optical flow and filtering information for the filter. The filtering information includes at least one of type information of the filter or parameter information of the filter.

According to an embodiment of the present disclosure, an image decoding apparatus including: at least one memory storage storing computer-executable instructions; and at least one processor communicatively coupled to the at least one memory storage. The at least one processor is configured to execute the computer-executable instructions to: obtain, from a bitstream, feature data of a preliminary optical flow and filtering information. The filtering information includes at least one of type information of a filter or parameter information of a filter; and obtain the preliminary optical flow by applying the feature data of the preliminary optical flow to a neural network based first decoder, generate an optical flow by applying the preliminary optical flow to a filter corresponding to the filtering information, and generate a current reconstructed image by using previous data and the optical flow

### BRIEF DESCRIPTION OF THE DRAWINGS

FIG. 1 is a diagram illustrating an optical flow encoding and decoding process based on AI, according to an embodiment.

FIG. 2 is a diagram illustrating an image encoding and decoding process based on AI, according to an embodiment.

FIG. 3 is a diagram illustrating an image encoding and decoding process based on AI, according to an embodiment.

FIG. 4 is a diagram illustrating a configuration of an image decoding apparatus according to an embodiment.

FIG. 5 is a diagram illustrating a configuration of an obtaining unit according to an embodiment.

FIG. 6 illustrates a table for explaining filtering information according to an embodiment.

FIG. 7 illustrates a table for explaining filtering information according to an embodiment.

FIG. 8 is a diagram illustrating a neural network to be used for a neural network filter, according to an embodiment.

FIG. 9 is a diagram showing a syntax for filtering information according to an embodiment.

FIG. 10 is a flowchart of an image decoding method according to an embodiment.

FIG. 11 is a diagram illustrating a configuration of an image encoding apparatus according to an embodiment.

FIG. 12 is a diagram illustrating a configuration of a generation unit according to an embodiment.

FIG. 13 is a diagram for explaining a method by which a prediction encoding unit selects a filter, according to an embodiment.

FIG. 14 is a diagram for explaining a method by which the prediction encoding unit selects a filter, according to an embodiment.

FIG. 15 is a flowchart of an image encoding method according to an embodiment.

FIG. 16 is a diagram illustrating a method of training a neural network that may be used for a neural network filter, according to an embodiment.

FIG. 17 is a diagram illustrating a method of training a first encoder, a first decoder, a second encoder, and a second decoder, according to an embodiment.

FIG. 18 is a diagram illustrating a method of training a first encoder, a first decoder, a second encoder, and a second decoder, according to an embodiment.

### DETAILED DESCRIPTION

The embodiments described herein are non-limiting example embodiments, and thus, the disclosure is not limited thereto and may be realized in various other forms.

An image decoding method according to an embodiment may include obtaining, from a bitstream, feature data of a preliminary optical flow and filtering information.

In an embodiment, the filtering information may include at least one of type information of a filter or parameter information of a filter.

An image decoding method according to an embodiment may include obtaining a preliminary optical flow by applying the feature data of the preliminary optical flow to a neural network based first decoder.

An image decoding method according to an embodiment may include generating an optical flow by applying the preliminary optical flow to a filter corresponding to the filtering information.

An image decoding method according to an embodiment may include generating a current reconstructed image by using previous data and the optical flow.

As the present disclosure allows for various changes and numerous embodiments, embodiments will be illustrated in the drawings and described in detail in the written description. However, this is not intended to limit the present disclosure to particular modes of practice, and it is to be appreciated that all changes, equivalents, and substitutes that do not depart from the spirit and technical scope of the present disclosure are encompassed in the present disclosure.

In the description of the embodiment, certain detailed explanations of the related art are omitted when it is deemed that they may unnecessarily obscure the essence of the present disclosure. Furthermore, numbers (for example, first, second, etc.) used in the process of describing an embodiment may correspond to an identification signal to distinguish one component from another.

In the present disclosure, expressions such as “at least one of a, b, or c” may denote “a”, “b”, “c”, “a and b”, “a and c”, “b and c”, “all of a, b, and c”, or modifications thereof.

In the present disclosure, when a component “connects” or is “connected” to another component, the component contacts or is connected to the other component directly, or through another component, unless explicitly stated otherwise.

In the present disclosure, components described as “units” or “modules” may be implemented such that two or more components are combined into one component, or one component is subdivided into two or more components. Furthermore, each of the components to be described below may additionally perform some or all of the functions of other components in addition to a main function thereof, and some of the main functions of each component may be exclusively performed by other components.

In the present disclosure, an ‘image’ may indicate a picture, a still image, a frame, a moving image composed of a plurality of consecutive still images, or a video.

In the present disclosure, a ‘current image’ may be an image that is a current encoding and decoding target. In an embodiment, a current image may be a block split from an image that is a current encoding and decoding target. For example, a current image may correspond to a slice, a tile, a largest coding unit, a coding unit, a prediction unit, or a transform unit split from an image.

In the present disclosure, a ‘previous image’ may be an image having an earlier encoding order and an earlier decoding order than a current image. In an embodiment, a previous image may correspond to a slice, a tile, a largest coding unit, a coding unit, a prediction unit, or a transform unit split from an image.

In the present disclosure, a ‘neural network’ may be a representative example of an artificial neural network model that imitates brain neurons, and the neural network is not limited to an artificial neural network model based on a particular algorithm. A neural network may be referred to as a deep neural network.

In the present disclosure, ‘parameters of a neural network’ may be values used in the computational process of each layer constituting the neural network. For example, the parameters of a neural network may be used when an input value is applied to a predetermined calculation formula. The parameters of a neural network, which are values set as a result of training, may be updated through a separate training data, as necessary.

In the present disclosure, ‘feature data’ may refer to data obtained as a neural network-based encoder processes input data. Feature data may be one-dimensional or two-dimensional data including various samples. The feature data may be referred to as latent representation. The feature data may represent features latent in data output by a decoder described below.

In the present disclosure, a ‘sample’ may refer to data assigned to a sampling position of an image or feature data and to be processed. For example, a pixel in a frame of a spatial domain may correspond to a sample. A unit including a plurality of samples may be defined as a block.

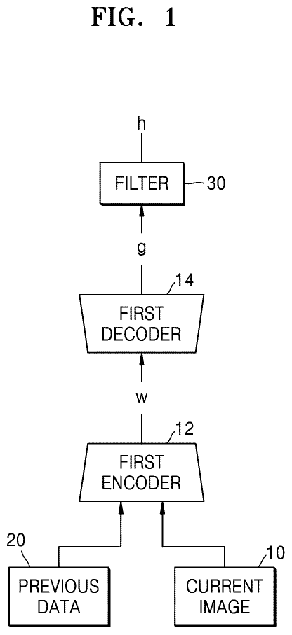

FIG. 1 is a diagram illustrating an optical flow encoding and decoding process based on AI, according to an embodiment.

Inter prediction may be a process of encoding and decoding a current image 10 by using temporal redundancy between the current image 10 and a previous reconstructed image. The previous reconstructed image may be an image obtained through decoding of a previous image.

A positional difference (or a motion vector) between blocks or samples in the current image 10 and reference blocks or reference samples in the previous reconstructed image may be used for inter prediction of the current image 10. Such a positional difference may be referred to as an optical flow. The optical flow may be defined as a set of motion vectors corresponding to samples or blocks in images.

The optical flow may indicate how positions of samples in a previous reconstructed image are changed in the current image 10, or where samples identical or similar to samples of the current image 10 are positioned in the previous reconstructed image.

For example, when a sample that is identical to or most similar to the sample located at (1, 1) in the current image 10 is located at (2, 1) in the previous reconstructed image, the optical flow or motion vector for the sample located at (1, 1) may be derived as (1 (=2-1), 0 (=1-1)).

In a process of encoding and decoding an optical flow using AI according to an embodiment, a first encoder 12 and a first decoder 14 may be used to obtain an optical flow for the current image 10.

The first encoder 12 and the first decoder 14 may be implemented as neural networks. The first encoder 12 and the first decoder 14 may be understood as neural networks to extract an optical flow.

In an embodiment, the first encoder 12 may be referred to as an optical flow encoder, and the first decoder 14 may be referred to as an optical flow decoder. In an embodiment, the first encoder 12 may be referred to as a motion vector encoder, and the first decoder 14 may be referred to as a motion vector decoder.

Referring to FIG. 1, previous data 20 and the current image 10 may be input to the first encoder 12. The first encoder 12 may process the current image 10 and the previous data 20 according to the parameters set as a result of training to output feature data w of a preliminary optical flow.

In the present disclosure, the previous data 20 may include at least one of a previous reconstructed image, feature data of a previous reconstructed image, a previous prediction image used to generate a previous reconstructed image, feature data of a previous prediction image, a previous preliminary optical flow used to generate a previous reconstructed image, feature data of a previous preliminary optical flow, a previous residual image used to generate a previous reconstructed image, or feature data of a previous residual image.

In an embodiment, the previous data 20 may refer to a previous reconstructed image itself or data obtained in a process of generating a previous reconstructed image.

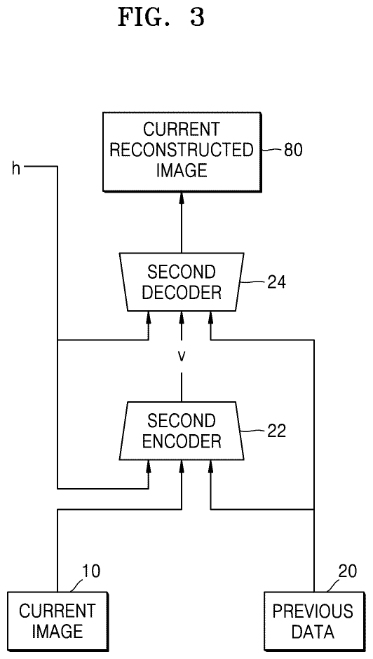

In an embodiment, the feature data of a previous reconstructed image, which is an example of the previous data 20, may be feature data output from a predetermined layer (a first layer or an intermediate layer) that is not a final layer among layers constituting a neural network (e.g., a second decoder 24 illustrated in FIG. 3) that outputs a previous reconstructed image.

In an embodiment, a previous prediction image that is an example of the previous data 20 may be used to generate a previous reconstructed image, and may be obtained through warping of an image reconstructed earlier than the previous reconstructed image. The feature data of a previous prediction image may be obtained by processing a previous prediction image through a neural network. In an embodiment, the feature data of a previous prediction image may be obtained through warping of the feature data of an image reconstructed earlier than the previous reconstructed image.

The feature data w of a preliminary optical flow may be input to the first decoder 14. The first decoder 14 may output a preliminary optical flow g by processing the feature data w that is input, according to the parameters set as a result of training.

In an embodiment, a certain process may be performed on the preliminary optical flow g for the encoding and decoding of the current image 10.

The performing a certain process on the preliminary optical flow g is because there is a possibility that the preliminary optical flow g is not accurate.

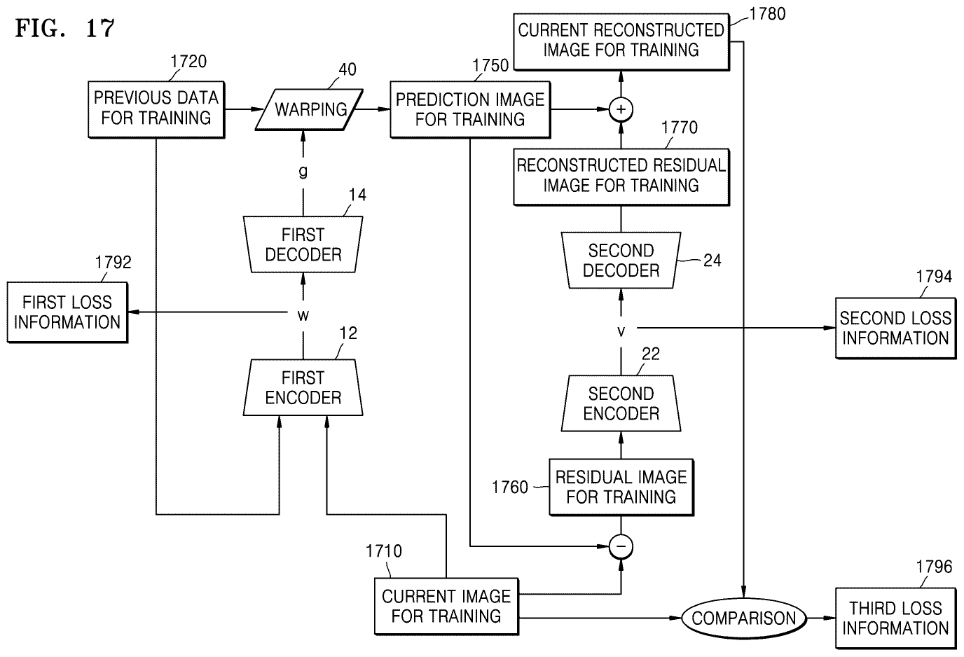

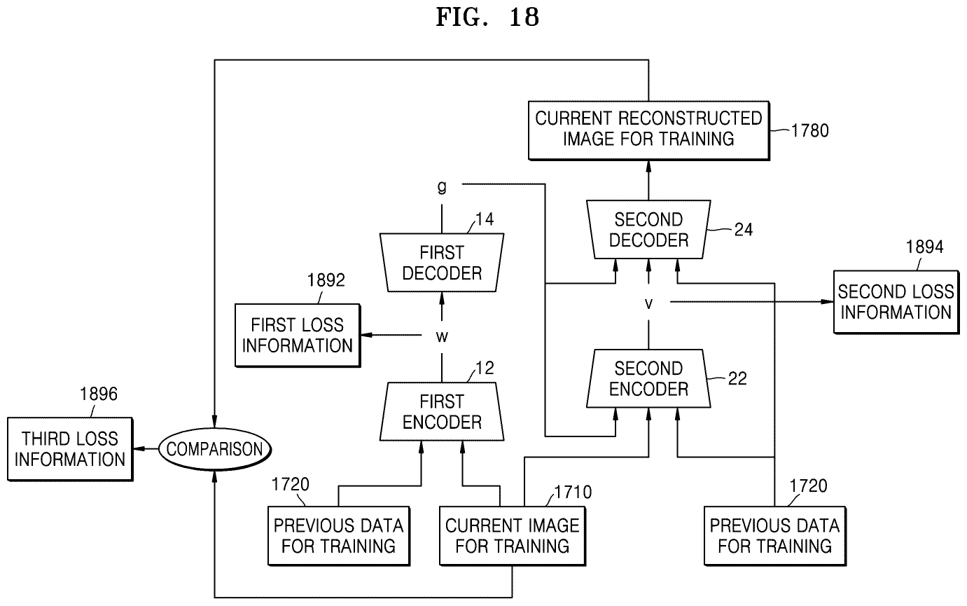

As described below with reference to FIGS. 17 and 18, as the first encoder 12 and the first decoder 14 are trained in a direction in which the bitrate of a bitstream decreases, a relatively low-quality preliminary optical flow g may be output. Furthermore, due to computational load and delay, there is a limit to the number of layers that may be included in the first encoder 12 and the first decoder 14, making it difficult to generate the preliminary optical flow g with high quality. Due to the low quality preliminary optical flow g, the size of residual data may be increased and thus the bitrate of a bitstream may increase.

In an embodiment, by performing post-processing on the preliminary optical flow g, the bitrate of a bitstream may be reduced.

As illustrated in FIG. 1, a filter 30 may be used for the post-processing of the preliminary optical flow g. The filter 30 may be selected from among a plurality of filters according to predetermined criteria. A filter selection method is described below.

As the preliminary optical flow g is filtered by the filter 30, an optical flow h may be generated. In an embodiment, as the preliminary optical flow g is applied to the filter 30, at least some of sample values of the preliminary optical flow g are changed, and the optical flow h including the changed sample values may be obtained. In an embodiment, the optical flow h may be referred to as a filtered optical flow.

Although FIG. 1 illustrates that the previous data 20 and the current image 10 are applied to the first encoder 12 and the feature data w of a preliminary optical flow is obtained from the first encoder 12, there may be a variety of methods for obtaining the feature data w of a preliminary optical flow.

For example, a preliminary optical flow is extracted from the previous data 20 and the current image 10, and the extracted preliminary optical flow may be applied to the first encoder 12. The feature data w of the preliminary optical flow output from the first encoder 12 may be input to the first decoder 14.

Furthermore, for example, a plurality of neural networks connected in series or parallel may be used to obtain the feature data w of the preliminary optical flow, and a plurality of neural networks connected in series or parallel may be used to obtain the preliminary optical flow g from the feature data w of the preliminary optical flow. The plurality of neural networks being connected in series may refer to a case in which an output of any one neural network is input to another neural network. The plurality of neural networks being connected in parallel may refer to a case in which any one neural network and another neural network separately process input data, and output data of the one neural network and output data of the other neural network are combined with each other.

In an embodiment, when the optical flow encoding and decoding process illustrated in FIG. 1 is implemented by an encoding apparatus and a decoding apparatus, the encoding apparatus may obtain the feature data w of a preliminary optical flow by using the current image 10 and the previous data 20. The encoding apparatus may generate a bitstream including the feature data w of the preliminary optical flow and information about the filter 30 applied to the preliminary optical flow g (hereinafter, referred to as filtering information), and transmit the generated bitstream to the decoding apparatus.

The decoding apparatus may obtain, from the bitstream, the feature data w of the preliminary optical flow and the filtering information. The decoding apparatus may obtain the preliminary optical flow g by processing the feature data w of the preliminary optical flow using the first decoder 14, and obtain the optical flow h by filtering the preliminary optical flow g according to the filtering information.

When the optical flow h for the current image 10 is obtained, the current image 10 may be encoded and decoded based on the optical flow h.

In an embodiment, the current image 10 may be encoded and decoded based on the optical flow h and the previous data 20.

In an embodiment, for the encoding and decoding of the current image 10, motion compensation may be applied to the previous data 20 based on the optical flow h. A prediction image similar to the current image 10 may be generated through the motion compensation.

In an embodiment, the prediction image may be determined as a current reconstructed image.

In an embodiment, a residual image which corresponds to the difference between the current image 10 and the prediction image may be obtained, and as the residual image and the prediction image are combined with each other, the current reconstructed image may be generated. Data for the residual image may be transmitted from the encoder to the decoder through a bitstream.

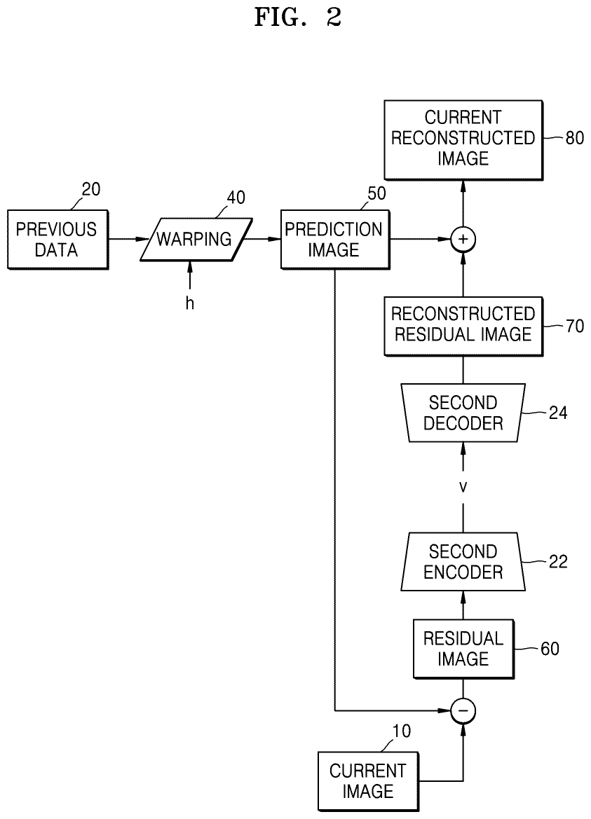

A process of encoding and decoding the current image 10 is described below with reference to FIGS. 2 and 3.

FIG. 2 is a diagram illustrating an Image encoding and decoding process based on AI, according to an embodiment.

In the process of encoding and decoding the current image 10 using AI, according to an embodiment, a second encoder 22 and the second decoder 24 may be used.

The second encoder 22 and the second decoder 24 may be implemented by neural networks. The second encoder 22 and the second decoder 24 may be understood as neural networks for encoding and decoding a residual image 60 corresponding to the difference between the current image 10 and a prediction image 50.

In an embodiment, the second encoder 22 may be referred to as a residual encoder, and the second decoder 24 may be referred to as a residual decoder.

In an embodiment, as the second encoder 22 and the second decoder 24 are used for encoding and decoding pixel values of the current image 10, the second encoder 22 may be referred to as a pixel encoder, and the second decoder 24 may be referred to as a pixel decoder.

Referring to FIG. 2, the previous data 20 may be warped through warping 40 based on the optical flow h, and as a result of the warping 40, the prediction image 50 may be obtained. The warping 40 may be a type of geometric transformation that moves positions of samples within an image.

In the embodiment illustrated in FIG. 2, in order to generate the prediction image 50, a previous reconstructed image may be used as the previous data 20. Accordingly, the prediction image 50 may be obtained through the warping 40 for the previous reconstructed image.

The prediction image 50 similar to the current image 10 may be obtained by applying the warping 40 to the previous data 20 based on the optical flow h representing a relative positional relationship between samples in the previous data 20 and samples in the current image 10.

For example, when a sample located at (1, 1) in the previous data 20 is most similar to a sample located at (2, 1) in the current image 10, the position of the sample located at (1, 1) in the previous data 20 may be changed to (2, 1) through the warping 40 based on the optical flow h.

In an embodiment, the warping 40 may be implemented based on a neural network, in which case, the previous data 20 and the optical flow h may be input into a neural network for the warping 40, and a prediction image 50 may be output from the neural network.

As the prediction image 50 generated from the previous data 20 is not the current image 10 itself, the residual image 60 corresponding to the difference between the prediction image 50 and the current image 10 may be obtained.

For example, the residual image 60 may be obtained by subtracting sample values in the prediction image 50 from sample values in the current image 10.

The residual image 60 may be input to the second encoder 22. The second encoder 22 may output feature data v of the residual image 60 by processing the residual image 60 according to the parameters set as a result of training.

The feature data v of the residual image 60 may be input to the second decoder 24. The second decoder 24 may output a reconstructed residual image 70 by processing the feature data v that is input, according to the parameters set as a result of training.

As the prediction image 50 and the reconstructed residual image 70 are combined with each other, a current reconstructed image 80 may be obtained. For example, the current reconstructed image 80 may be obtained by adding sample values in the prediction image 50 and sample values in the reconstructed residual image 70.

When the image encoding and decoding process illustrated in FIG. 2 is implemented by the encoding apparatus and the decoding apparatus, the encoding apparatus may obtain the feature data v of the residual image 60 by using the second encoder 22. The encoding apparatus may generate a bitstream including the feature data v of the residual image 60, and transmit the generated bitstream to the decoding apparatus.

The decoding apparatus may obtain, from the bitstream, the feature data v of the residual image 60. The decoding apparatus may obtain the reconstructed residual image 70 by processing the feature data v of the residual image 60 using the second decoder 24, and obtain the current reconstructed image 80 by combining the prediction image 50 generated from the previous data 20 based on the optical flow h and the reconstructed residual image 70.

FIG. 3 is a diagram illustrating an Image encoding and decoding process based on AI, according to an embodiment.

Referring to FIG. 3, the current image 10, the previous data 20, and the optical flow h may be input to the second encoder 22. The second encoder 22 may output the feature data v of a residual image by processing the input data according to the parameters set as a result of training.

In the embodiment illustrated in FIG. 2, the residual image 60 corresponding to the difference between the prediction image 50 generated through the warping 40 and the current image 10 is input to the second encoder 22, whereas, in the embodiment illustrated in FIG. 3, it may be understood that the second encoder 22 performs together the warping process for the previous data 20 and the process of obtaining the residual image.

As, in FIG. 3, the residual image 60 is not input to the second encoder 22, in an embodiment, it may be referred that the feature data of samples of the current image 10 may be output from the second encoder 22.

In an embodiment, a prediction image that is generated from the previous data 20 (for example, the previous reconstructed image) based on the optical flow h, and the current image 10, may be input to the second encoder 22.

In an embodiment, the feature data of the prediction image generated from the feature data of the previous reconstructed image based on the optical flow h, and the current image 10, may be input to the second encoder 22.

In an embodiment, the prediction image generated from the previous reconstructed image based on the optical flow h, the feature data of the prediction image generated from the feature data of the previous reconstructed image based on the optical flow h, and the current image 10 may be input to the second encoder 22.

The previous data 20, the optical flow h, and the feature data v of the residual image may be input to the second decoder 24. The second decoder 24 may output the current reconstructed image 80 by processing the input data according to the parameters set as a result of training.

In the embodiment illustrated in FIG. 2, the current reconstructed image 80 is obtained by combining the prediction image 50 generated through the warping 40 and the residual image 70 output from the second decoder 24, whereas, in the embodiment illustrated in FIG. 3, it may be understood that the second decoder 24 performs together the warping process for the previous data 20 and the combination process of the residual image and the prediction image.

In an embodiment, the prediction image 50 generated from the previous data 20 (for example, the previous reconstructed image) based on the optical flow h, and the feature data v of the residual image, may be input to the second decoder 24.

In an embodiment, the feature data of the prediction image generated from the feature data of the previous reconstructed image based on the optical flow h, and the feature data v of the residual image, may be input to the second decoder 24.

In an embodiment, the prediction image generated from the previous reconstructed image based on the optical flow h, the feature data of the prediction image generated from the feature data of the previous reconstructed image based on the optical flow h, and the feature data v of the residual image may be input to the second decoder 24.

When the image encoding and decoding process illustrated in FIG. 3 is implemented by the encoding apparatus and the decoding apparatus, the encoding apparatus may obtain the feature data v of the residual image by using the second encoder 22. The encoding apparatus may generate a bitstream including the feature data v of the residual image and transmit the generated bitstream to the decoding apparatus.

The decoding apparatus may obtain, from the bitstream, the feature data v of the residual image. The decoding apparatus may obtain the current reconstructed image 80 by processing the feature data v of the residual image, the previous data 20, and the optical flow h by using the second decoder 24.

While the process of encoding and decoding the optical flow h is described with reference to FIG. 1, and the process of encoding and decoding the current image 10 is described separately with reference to FIGS. 2 and 3, the process of encoding and decoding the optical flow h may be understood as a part of the process of encoding and decoding the current image 10.

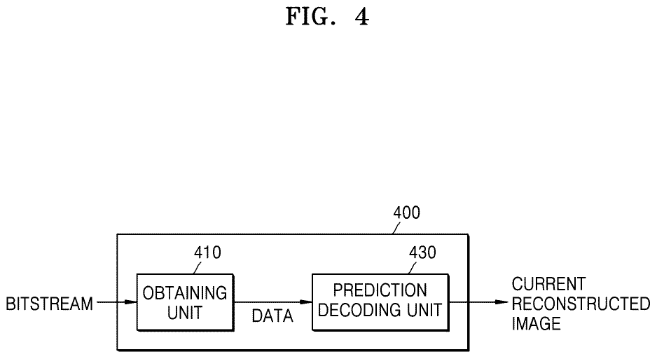

FIG. 4 is a diagram illustrating a configuration of an image decoding apparatus 400 according to an embodiment.

Referring to FIG. 4, the image decoding apparatus 400 may include an obtaining unit 410 and a prediction decoding unit 430.

The obtaining unit 410 and the prediction decoding unit 430 may be implemented by at least one processor. The obtaining unit 410 and the prediction decoding unit 430 may operate according to at least one instruction stored in memory.

Although FIG. 4 illustrates the obtaining unit 410 and the prediction decoding unit 430 separately, the obtaining unit 410 and the prediction decoding unit 430 may be implemented through one processor. For example, the obtaining unit 410 and the prediction decoding unit 430 may be implemented by a dedicated processor, or by a combination of general purpose processors, such as an application processor (AP), a central processing unit (CPU), or a graphical processing unit (GPU), and software.

The obtaining unit 410 and the prediction decoding unit 430 may be configured with a plurality of processors. For example, the obtaining unit 410 and the prediction decoding unit 430 may be implemented by a combination of dedicated processors, or through a combination of multiple general purpose processors, such as AP, CPU, or GPU, and software.

In an embodiment, the image decoding apparatus 400 may use the first decoder 14 and the second decoder 24 to generate a current reconstructed image. The first decoder 14 and the second decoder 24 may be stored in the memory. In an embodiment, the first decoder 14 and the second decoder 24 may be implemented by an AI processor.

The obtaining unit 410 may obtain a bitstream including an encoding result for the current image.

The obtaining unit 410 may receive a bitstream from an image encoding apparatus through a network. In an embodiment, the obtaining unit 410 may obtain a bitstream from a data storage medium including a magnetic medium, such as a hard disk, a floppy disk, and a magnetic tape, an optical recording medium, such as CD-ROM and DVD, and a magneto-optical medium such as a floptical disk.

The obtaining unit 410 may obtain data corresponding to the encoding result for the current image by parsing the bitstream.

In an embodiment, the data corresponding to the encoding result for the current image may include at least one of the feature data of a preliminary optical flow, the feature data of a residual image, or the filtering information.

In an embodiment, the obtaining unit 410 may obtain the feature data of a preliminary optical flow, the feature data of a residual image, and the filtering information by obtaining a first bitstream corresponding to the feature data of a preliminary optical flow and the filtering information and a second bitstream corresponding to the feature data of a residual image, and parsing each of the first bitstream and the second bitstream.

The data corresponding to the encoding result for the current image may be transmitted to the prediction decoding unit 430, and the prediction decoding unit 430 may generate a current reconstructed image corresponding to the current image by using the obtained data.

In an embodiment, the current reconstructed image may be transmitted to a display apparatus for reproduction.

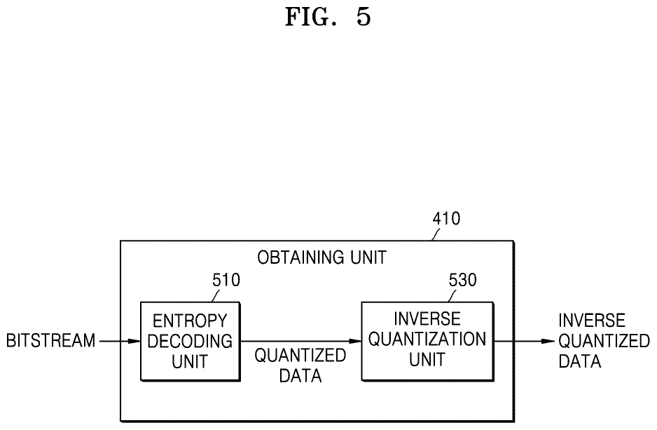

FIG. 5 is a diagram illustrating a configuration of the obtaining unit 410 according to an embodiment.

Referring to FIG. 5, the obtaining unit 410 may include an entropy decoding unit 510 and an inverse quantization unit 530.

The entropy decoding unit 510 may obtain the feature data of a preliminary optical flow, the feature data of a residual image, and the filtering information by entropy coding the bitstream.

In an embodiment, at least one of the feature data of a preliminary optical flow, the feature data of a residual image, or the filtering information may be quantized. In this case, the inverse quantization unit 530 may obtain inversely quantized data by inverse quantizing the quantized data. The inversely quantized data may be transmitted to the prediction decoding unit 430.

In an embodiment, when the feature data of a preliminary optical flow and the feature data of a residual image are quantized, the inverse quantization unit 530 may obtain the inversely quantized the feature data of a preliminary optical flow and the inversely quantized feature data of a residual image by inverse quantizing the quantized feature data of a preliminary optical flow and the quantized feature data of a residual image.

In an embodiment, the obtaining unit 410 may further include an inverse transform unit. The inverse transform unit may perform an inverse transform on the inversely quantized data output from the inverse quantization unit 530 from a frequency domain to a spatial domain.

When an image encoding apparatus 1100 to be described below transforms the data corresponding to the encoding result for the current image from a spatial domain to a frequency domain, the inverse transform unit may inversely transform the inversely quantized data output from the inverse quantization unit 530 from a frequency domain to a spatial domain.

In an embodiment, the obtaining unit 410 may not include the inverse quantization unit 530. In other words, the data corresponding to the encoding result for the current image may be obtained through processing by the entropy decoding unit 510.

Referring back to FIG. 4, the prediction decoding unit 430 may generate a current reconstructed image by using the data received from the obtaining unit 410.

In an embodiment, the prediction decoding unit 430 may obtain a preliminary optical flow by applying the feature data of the preliminary optical flow to the first decoder 14. The prediction decoding unit 430 may obtain an optical flow by filtering the preliminary optical flow based on a filter indicated by the filtering information.

In an embodiment, the prediction decoding unit 430 may generate a current reconstructed image based on the optical flow and the previous data.

For example, the prediction decoding unit 430 may generate a current reconstructed image by performing motion compensation on the previous data based on the optical flow.

Furthermore, for example, the prediction decoding unit 430 may generate a prediction image by warping the previous data based on the optical flow. The prediction decoding unit 430 may obtain a reconstructed residual image by applying the feature data of a residual image to the second decoder 24. The prediction decoding unit 430 may generate a current reconstructed image by combining the prediction image and the reconstructed residual image.

Furthermore, for example, the prediction decoding unit 430 may obtain a current reconstructed image by applying the optical flow, the previous data, and the feature data of a residual image to the second decoder 24.

Furthermore, for example, the prediction decoding unit 430 may obtain a current reconstructed image by applying, to the second decoder 24, the prediction image generated from the previous data based on the optical flow and the feature data of a residual image.

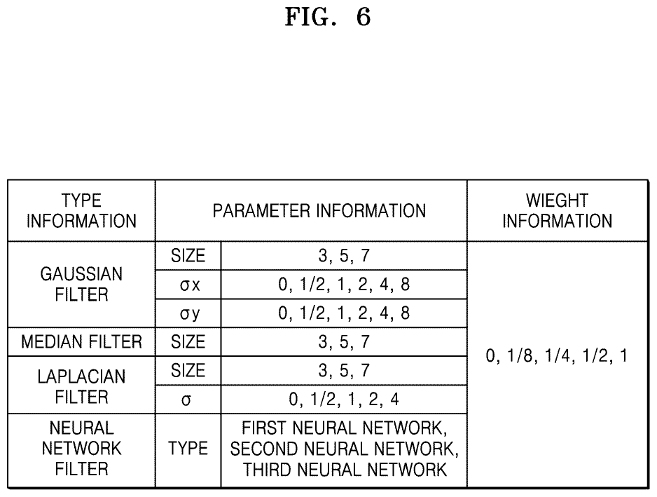

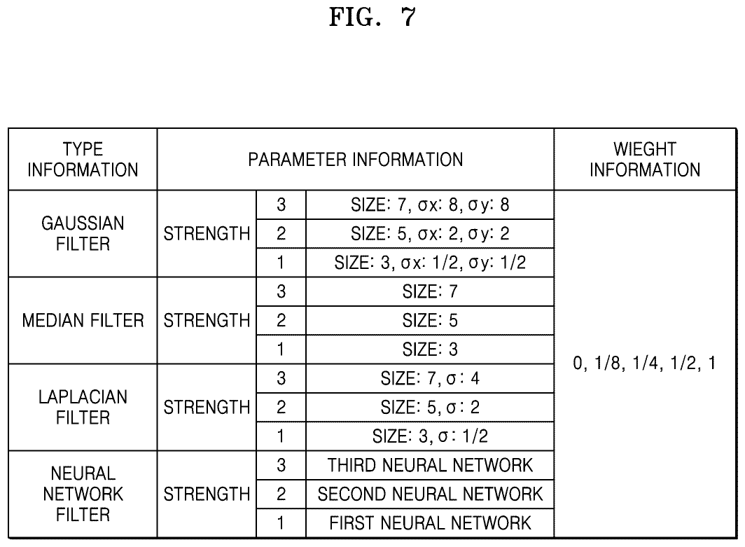

A process of filtering a preliminary optical flow performed by the prediction decoding unit 430 is described below with reference to FIGS. 6 and 7.

FIG. 6 illustrates a table for explaining filtering information according to an embodiment

In an embodiment, the prediction decoding unit 430 may filter a preliminary optical flow by using a filter indicated by filtering information.

The filtering information is information to specify a filter used for filtering a preliminary optical flow, and may include, for example, at least one of type information of a filter, parameter information of a filter, or weight information.

In an embodiment, the type information of a filter may indicate the type of a filter used for filtering a preliminary optical flow. For example, the type information of a filter may indicate at least one of a Gaussian filter, a median filter, a bilateral filter, or a neural network filter.

When the type information of a filter indicates a Gaussian filter, the prediction decoding unit 430 may filter a preliminary optical flow by using the Gaussian filter.

The type information of a filter illustrated in FIG. 6 is a mere example, and various filters may be used for filtering a preliminary optical flow. For example, various types of filters capable of filtering sample values in two-dimensional data may be used by the prediction decoding unit 430.

In an embodiment, the type information of a filter may indicate a plurality of filters. For example, the type information of a filter may indicate a Gaussian filter and a neural network filter.

In an embodiment, when there is an agreement between the image decoding apparatus 400 and the image encoding apparatus about which type of filter to use, the filtering information may not include the type information of a filter.

In an embodiment, the parameter information of a filter may indicate values of parameters of a filter. Although even identical Gaussian filters may have different filtering effects depending on what values the parameters have, the image encoding apparatus may transmit signals, to the image decoding apparatus 400, parameter information indicating the values of the parameters to be set in the Gaussian filter.

The parameters of a filter may vary depending on the type of the filter. For example, as illustrated in FIG. 6, the parameters of a Gaussian filter may include the size of a filter kernel, a standard deviation ox in an x-axis direction (or a horizontal direction), and a standard deviation oy in a y-axis direction (or a vertical direction. Furthermore, for example, the parameters of a median filter may include the size of a filter kernel, and the parameters of a Laplacian filter may include the size of a filter kernel and a standard deviation. Furthermore, for example, the parameters of a neural network filter may refer to at least one neural network among a plurality of neural networks to be used as a neural network filter.

In an embodiment, the parameters of a filter may be referred to as setting items of a filter, and the values of the parameters may be referred to as setting values.

In an embodiment, when the type information of a filter indicates a plurality of filters, the parameter information of each of the plurality of filters may be included in the filtering information.

In an embodiment, the parameter information of a filter may include an index or flag that indicates any one of a plurality of candidate values that may be set for a particular parameter. For example, the parameter information of a Gaussian filter may include an index indicating any one of {3, 5, 7} to be used as a kernel size, an index indicating any one of {0, ½, 1, 2, 4, 8} to be used as an x-axis direction standard deviation, and an index indicating any one of {0, ½, 1, 2, 4, 8} to be used as an y-axis direction standard deviation.

In an embodiment, the parameter information of a filter may include the values of parameters themselves.

In an embodiment, when a value to be used for a particular parameter among the parameters of a filter is agreed upon in advance between the image decoding apparatus 400 and the image encoding apparatus, the information indicating the agreed parameter value may not be included in the filtering information. For example, when the image decoding apparatus 400 and the image encoding apparatus agree to set the size of a Gaussian filter to 3, the image encoding apparatus may transmit, as the parameter information of the Gaussian filter, the value of the x-axis direction standard deviation and the value of the y-axis direction standard deviation to the image decoding apparatus 400, while not transmitting the size value of the Gaussian filter to the image decoding apparatus 400.

The prediction decoding unit 430 may filter a preliminary optical flow with a filter corresponding to the filtering information. For example, when the type information of the filtering information indicates a Gaussian filter, and the parameter information indicates that the size is 3, the x-axis direction standard deviation is 1, and the y-axis direction standard deviation is 2, the prediction decoding unit 430 may filter a preliminary optical flow with a filter kernel having a size of 3 and sample values corresponding to the x-axis direction standard deviation of 1 and the y-axis direction standard deviation of 2.

In an embodiment, the prediction decoding unit 430 may determine the values of the parameters of a filter based on the filtering strength of a filter. For example, when the filtering strength indicates 3, the prediction decoding unit 430 may determine the values of parameters corresponding to the filtering strength of 3. In other words, the values of parameters corresponding to the filtering strength of a filter may be determined in advance.

In an embodiment, when the type information of a filter indicates a Gaussian filter, a median filter, or a Laplacian filter, the prediction decoding unit 430 may obtain an optical flow through a convolution operation using a filter kernel corresponding to a Gaussian filter, a median filter, or a Laplacian filter and a preliminary optical flow.

In an embodiment, when the type information of a filter indicates a neural network filter, the prediction decoding unit 430 may obtain an optical flow by applying the preliminary optical flow to the neural network indicated by the parameter information.

In an embodiment, the weight information included in the filtering information may indicate a weight used for the weighted sum among a plurality of candidate weights.

In an embodiment, the prediction decoding unit 430 may obtain a filtered preliminary optical flow by filtering the preliminary optical flow with a filter specified by the type information and the parameter information. The prediction decoding unit 430 may obtain an optical flow by calculating a weighted sum of the filtered preliminary optical flow and the preliminary optical flow according to the weight indicated by the weight information.

For example, the optical flow may be generated according to Equation 1 below.

$$P 3 = w 1 * P 1 + w 2 * P 2 \qquad [ Equation 1 ]$$

In Equation 1, P1 may correspond to a preliminary optical flow, P2 may correspond to a filtered preliminary optical flow, and P3 may correspond to an optical flow. Furthermore, w1 and w2 are weights applied to P1 and P2, respectively, and may be identified from the weight information.

In an embodiment, w2 may be a weight indicated by the weight information, and w1 may be a−w2. a, which is a predetermined integer, may be, for example, 1. For example, when the weight information indicates ⅛, w2 may be ⅛, and w1 may be ⅞.

In an embodiment, w1 may be a weight indicated by the weight information, and w2 may be a-w1.

In an embodiment, the prediction decoding unit 430 may obtain a first filtered preliminary optical flow by filtering the preliminary optical flow with a first filter indicated by the type information, and obtain a second filtered preliminary optical flow by filtering the preliminary optical flow with a second filter indicated by the type information. The prediction decoding unit 430 may obtain an optical flow by calculating a weighted sum of the first filtered preliminary optical flow and the second filtered preliminary optical flow according to the weight indicated by the weight information.

For example, the optical flow may be generated according to Equation 2 below.

$$P 3 = w 1 * P2\_a + w 2 * P2\_b \qquad [ Equation 2 ]$$

In Equation 2, P2_amay corresponds to a first filtered preliminary optical flow, P2_b may correspond to a second filtered preliminary optical flow, and P3 may correspond to the optical flow. Furthermore, w1 and w2 are weights applied to P2_a and P2_b, respectively, and may be identified from the weight information.

In an embodiment, w2 may be a weight indicated by the weight information, and w1 may be a-w2. a, which is a predetermined integer, may be, for example, 1. For example, when the weight information indicates ⅛, w2 may be ⅛, and w1 may be ⅞. In an embodiment, w1 may be a weight indicated by the weight information, and w2 may be a-w1.

In an embodiment, when the type information of a filter indicates n filters (n is an integer of 1 or more), the weight information may indicates n−1 candidates of the plurality of candidate weights (e.g., 0, ⅛, ¼, ½, and 1 illustrated in FIG. 6). For example, when the type information of a filter indicates three filters, the weight information may indicate two candidate weights of the plurality of candidate weights. The first weight indicated by the weight information may be applied to the first filtered preliminary optical flow generated based on the first filter among the three filters indicated by the type information, and the second weight indicated by the weight information may be applied to the second filtered preliminary optical flow generated based on the second filter among the three filters indicated by the type information. A value obtained by subtracting the sum of the first weight and the second weight from a predetermined value (e.g., 1) may be applied to the third filtered preliminary optical flow generated based on the third filter indicated by the type information.

In an embodiment, the parameter information may indicate the strength of a filter, and the prediction decoding unit 430 may determine the parameter values of a filter based on the strength of a filter. This will be described with reference to FIG. 7.

FIG. 7 illustrates a table for explaining filtering information according to an embodiment

In an embodiment, the parameter information may indicate the strength of a filter indicated by the type information. The strength of a filter may be classified by a plurality of values, and for example, a larger strength value may indicate a stronger filter.

Parameter values corresponding to the strength of a filter may be agreed with the image decoding apparatus 400 and the image encoding apparatus 1100. Accordingly, the prediction decoding unit 430 may determine the parameter values of a filter based on the strength of a filter indicated by the parameter information.

For example, referring to FIG. 7, when the type information indicates a Gaussian filter, and the parameter information indicates a strength of 3, the prediction decoding unit 430 may determine the size of a Gaussian filter as 7, the x-axis direction standard deviation as 8, and the y-axis direction standard deviation as 8.

Furthermore, for example, when the type information indicates a Gaussian filter and the parameter information indicates a strength of 1, the prediction decoding unit 430 may determine the size of a Gaussian filter as 3, the x-axis direction standard deviation as ½, and the y-axis direction standard deviation as ½.

In an embodiment, the parameter information may include an index or flag indicating the strength of a filter. Accordingly, the prediction decoding unit 430 may determine the values of the parameters of a filter through the index or flag corresponding to the parameter information.

As described above, when the type information of a filter indicates a neural network filter, the parameter information may indicate a neural network of a plurality of neural networks to be used as a neural network filter.

The prediction decoding unit 430 may store in advance a plurality of neural networks to be used as a neural network filter, and apply a preliminary optical flow to a neural network of a plurality of neural networks indicated by the parameter information.

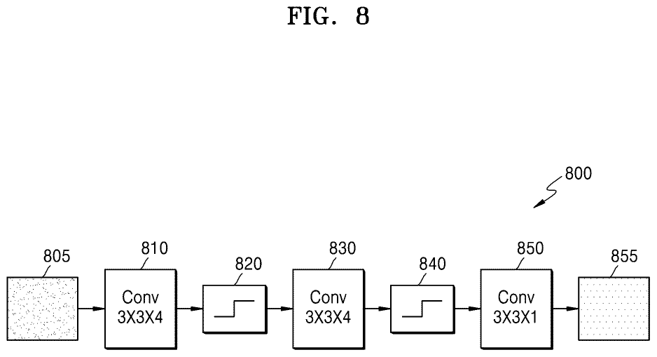

FIG. 8 is a diagram illustrating a neural network to be used for a neural network filter, according to an embodiment.

A neural network 800 illustrated in FIG. 8 may be any one of the first neural network, the second neural network, and the third neural network illustrated in FIGS. 6 and 7.

As illustrated in FIG. 8, a preliminary optical flow 805 may be input to a first convolution layer 810.

3×3×4 marked on the first convolution layer 810 refers to an example of convolution processing of one preliminary optical flow 805 by using four filter kernels each having a size of 3×3. As a result of the convolution processing, four feature maps may be generated by the four filter kernels.

The feature maps generated by the first convolution layer 810 may exhibit the unique characteristics of the preliminary optical flow 805. For example, each feature map may represent vertical direction characteristics, horizontal direction characteristics, or edge characteristics of the preliminary optical flow 805.

The feature maps generated by the first convolution layer 810 may be input to a first activation layer 820.

The first activation layer 820 may provide non-linear characteristics to each feature map. The first activation layer 820 may include a sigmoid function, a Tanh function, or a rectified linear unit (ReLU) function, but the disclosure is not limited thereto.

The providing of the non-linear characteristics by the first activation layer 820 may refer to changing and outputting some sample values of feature maps. In this state, the change may be performed by applying the non-linear characteristics.

The first activation layer 820 may determine whether to pass the sample values of feature map to a second convolution layer 830. For example, some sample values of the feature map may be activated by the first activation layer 820 and passed to the second convolution layer 830, while some sample values may be deactivated by the first activation layer 820 and not passed to the second convolution layer 830. The unique characteristics of the preliminary optical flow 805 represented by the feature maps may be emphasized by the first activation layer 820.

The feature maps output from the first activation layer 820 may be input to the second convolution layer 830. 3×3×4 marked on the second convolution layer 830 refers to an example of convolution processing of the input feature maps by using four filter kernels each having a size of 3×3. The output of the second convolution layer 830 may be input to a second activation layer 840. The second activation layer 840 may provide non-linear characteristics to the input feature maps.

The feature maps output from the second activation layer 840 may be input to a third convolution layer 850. 3×3×1 marked on the third convolution layer 850 refers to an example of convolution processing of one output data 855 by using one filter kernel having a size of 3×3.

In an embodiment, the output data 855 may be an optical flow or a filtered preliminary optical flow used for the weighted sum.

Although FIG. 8 illustrates that the neural network 800 includes three convolution layers 810, 830, and 850 and two activation layers 820 and 840, this is merely an example. In an embodiment, the numbers of convolution layers and activation layers included in the neural network 800 may be variously changed.

In an embodiment, the neural network 800 may be implemented through a recurrent neural network (RNN).

In an embodiment, the image decoding apparatus 400 and the image encoding apparatus 1100 described below may include at least one arithmetic logic unit (ALU) for the convolution operation and the operation of the activation layer described above.

The ALU may be implemented by a processor. For the convolution operation, the ALU may include a multiplier that performs a product operation between sample values of input data and sample values of a filter kernel and an adder that adds result values of the multiplication.

For the operation of the activation layer, the ALU may include a multiplier that multiplies the input sample value by a weight used for a predetermined sigmoid function, Tanh function, or ReLU function, and a comparator that compares the multiplied result with a predetermined value to determine whether to pass the input sample value to the next layer.

In an embodiment, as a neural network filter, a plurality of different neural networks (e.g., the first neural network, the second neural network, and the third neural network illustrated in FIG. 6) may be used, and filtering results based on a plurality of different neural networks may be different from each other. To produce different filtering results, the plurality of neural networks may each have different parameters as trained with different training data, or have different internal structures from each other.

For example, when the first neural network and the second neural network have the same internal structure, by differentiating the training data used for training the first neural network and the second neural network, the filtering results based on the first neural network and the second neural network may differ from each other. The internal structures of the first neural network and the second neural network being the same may refer to, for example, the number of layers included in the first neural network and the second neural network being the same, and the size of a filter kernel and the number of filter kernels used in the layers being the same.

Furthermore, for example, when the internal structures of the first neural network and the second neural network are different from each other (e.g., when the first neural network has three convolution layers, while the second neural network has five convolution layers), the filtering result based on the first neural network and the filtering result based on the second neural network may be different from each other.

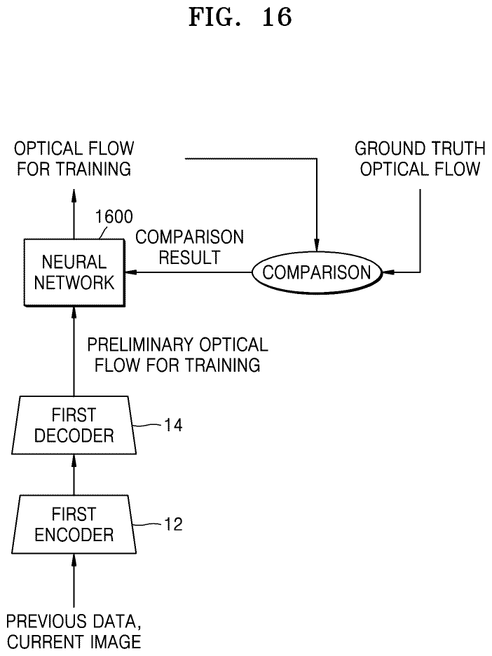

In an embodiment, a plurality of neural networks to be used as a neural network filters may have different filtering strengths from each other. For example, the filtering strength of the first neural network may be the strongest, and the filtering strength of the third neural network may be the lowest. The filtering strengths of a plurality of neural networks may be determined according to the internal structure of each neural network and the type of training data. A neural network training method is described below with reference to FIG. 16.

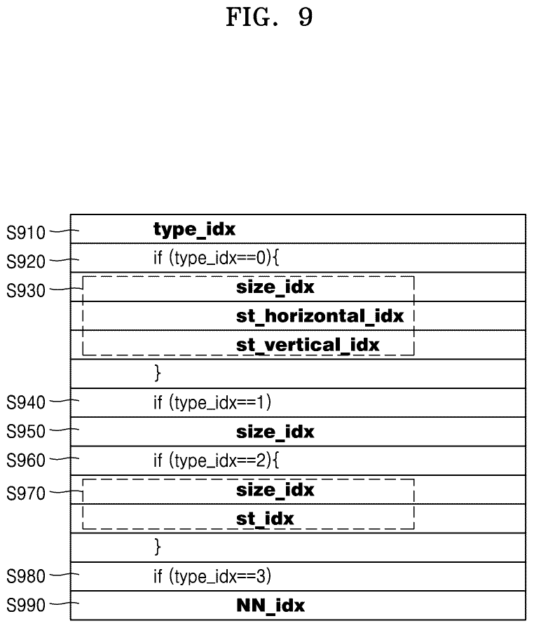

FIG. 9 is a diagram showing a syntax for filtering information according to an embodiment.

In an embodiment, filtering information may be obtained from a bitstream in units of a picture sequence (e.g., a sequence parameter set (SPS)), a picture (e.g., a picture parameter set (PPS)), or a block (e.g., slice data).

For example, when the filtering information is obtained in units of picture sequences, the same filtering information may be applied to a picture sequence including the current image.

Furthermore, for example, when the filtering information is obtained in units of pictures, filtering information for the current image and filtering information for other images may be obtained independently.

Furthermore, for example, when the current image corresponds to a current block split from an image, filtering information may be obtained in units of blocks, and in this case, filtering information for the current block and filtering information for other bocks may be obtained independently of each other.

In an embodiment, the type information, the parameter information, and the weight information included in the filtering information may be obtained from different units.

For example, while the type information of a filter may be obtained in units of picture sequences (e.g., SPS), the parameter information and/or weight information may be obtained in units of pictures (e.g., PPS) or blocks (e.g., slice data).

Furthermore, for example, while the type information of a filter may be obtained in units of pictures (e.g., PPS), the parameter information and/or weight information may be obtained in units of blocks (e.g., slice data).

Furthermore, for example, the type information of a filter may be obtained in units of picture sequences (e.g., SPS), the parameter information may be obtained in units of pictures (e.g., PPS), and the weight information may be obtained in units of blocks (e.g., slice data).

In an embodiment, information indicating whether the filtering of a preliminary optical flow is needed may be included in a bitstream, and when the corresponding information indicates that filtering is necessary, the prediction decoding unit 430 may obtain filtering information and may filter the preliminary optical flow based on the obtained filtering information. When the information indicating whether the filtering of a preliminary optical flow is needed indicates that filtering is not necessary, the prediction decoding unit 430 may determine the preliminary optical flow as an optical flow without obtaining filtering information.

In an embodiment, the information indicating whether the filtering of a preliminary optical flow is needed may be obtained from a bitstream in units of picture sequences (e.g., SPS), pictures (e.g., PPS), or blocks (e.g., slice data).

For example, while the information indicating whether the filtering a preliminary optical flow is needed may be obtained in units of picture sequences (e.g., SPS), the filtering information may be obtained in units of pictures (e.g., PPS) or blocks (e.g., slice data).

Furthermore, for example, while the information indicating whether the filtering of a preliminary optical flow is needed may be obtained in units of pictures (e.g., PPS), the filtering information may be obtained in units of blocks (e.g., slice data).

Referring to FIG. 9, in S910, type_idx that indicates the type of a filter may be obtained from a bitstream. The type of a filter to be applied to a preliminary optical flow may be determined among a plurality of different types of filters depending on the value indicated by the type_idx.

In an embodiment, when the filtering of a preliminary optical flow is determined to be necessary, the type_idx may be obtained from a bitstream.

In S920, when the type_idx is 0, for example, the type_idx indicates a Gaussian filter, in S930, size_idx indicating a size, st_horizontal_idx indicating an x-axis direction standard deviation, and st_vertical_idx indicating a y-axis direction standard deviation may be obtained from a bitstream. The prediction decoding unit 430 may determine the parameter values of the Gaussian filter from the size_idx, the st_horizontal_idx, and the st_vertical_idx, and filter a preliminary optical flow with the Gaussian filter having the determined parameter values.

In S940, when the type_idx is 1, for example, the type_idx indicates a median filter, in S950, the size_idx indicating a size may be obtained from the bitstream. The prediction decoding unit 430 may determine the parameter values of the median filter from the size_idx, and filter a preliminary optical flow with the median filter having the determined parameter values.

In S960, when the type_idx is 2, for example, the type_idx indicates a Laplacian filter, in S970, the size_idx indicating a size and st_idx indicating a standard deviation may be obtained from the bitstream. The prediction decoding unit 430 may determine the parameter values of the Laplacian filter from the size_idx and the st_idx, and filter a preliminary optical flow with the Laplacian filter having the determined parameter values.

In S980, when the type_idx is 3, for example, the type_idx indicates a neural network filter, in S990, NN_idx indicating a neural network used as a neural network filter may be obtained from the bitstream. The prediction decoding unit 430 may apply a preliminary optical flow to a neural network indicated by the NN_idx.

Although it is not illustrated in FIG. 9, when the type_idx is 0, 1, 2, or 3, weight information for weighted sum of a preliminary optical flow and a filtered preliminary optical flow may be further obtained from the bitstream.

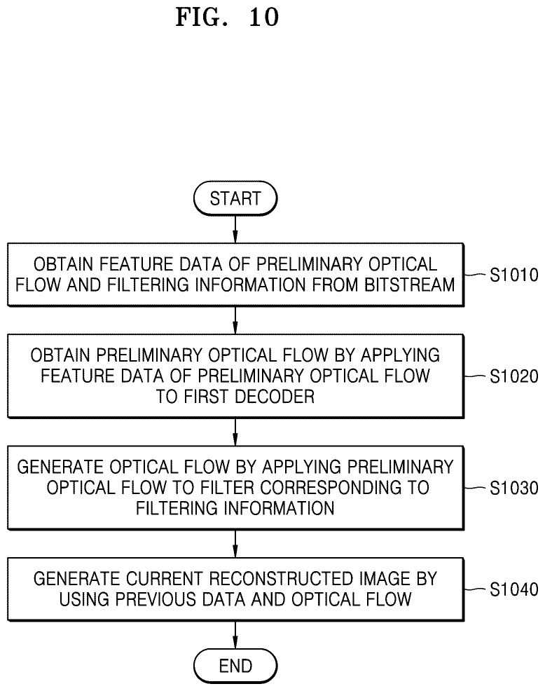

FIG. 10 is a flowchart of an image decoding method according to an embodiment.

In S1010, the image decoding apparatus 400 may obtain feature data of a preliminary optical flow and filtering information from a bitstream.

In an embodiment, the image decoding apparatus 400 may obtain, from the bitstream, information indicating whether filtering of a preliminary optical flow is necessary, and when the obtained information indicates that the filtering is needed, obtain filtering information from the bitstream.

In an embodiment, the image decoding apparatus 400 may further obtain, from the bitstream, the feature data of a residual image.

In an embodiment, the image decoding apparatus 400 may obtain the feature data of a preliminary optical flow, the feature data of a residual image, and the filtering information by performing entropy decoding, inverse quantization, and/or inverse transform on the bitstream.

In S1020, the image decoding apparatus 400 may obtain a preliminary optical flow by applying the feature data of the preliminary optical flow to the first decoder 14.

The first decoder 14 may output a preliminary optical flow by processing the feature data of the preliminary optical flow according to the parameters set through training.

In S1030, the image decoding apparatus 400 may generate an optical flow by applying the preliminary optical flow to a filter corresponding to the filtering information.

As the process of filtering a preliminary optical flow by using a filter corresponding to the filtering information is described above, a detailed description thereof is omitted.

In S1040, the image decoding apparatus 400 may generate a current reconstructed image by using previous data and the optical flow. A current reconstructed image may be transmitted to a display for output.

In an embodiment, the image decoding apparatus 400 may obtain a current reconstructed image by performing motion compensation on the previous data based on the optical flow.

In an embodiment, the image decoding apparatus 400 may generate a prediction image by warping the previous data based on the optical flow. The image decoding apparatus 400 may obtain a reconstructed residual image by applying the feature data of a residual image to the second decoder 24. The image decoding apparatus 400 may generate a current reconstructed image by combining the prediction image and the reconstructed residual image.

In an embodiment, the prediction image may be determined as a current reconstructed image.

In an embodiment, the image decoding apparatus 400 may obtain a current reconstructed image by applying the optical flow, the previous data, and the feature data of a residual image to the second decoder 24.

In an embodiment, the image decoding apparatus 400 may obtain a current reconstructed image by applying, to the second decoder 24, the prediction image generated from the previous data based on the optical flow and the feature data of a residual image.

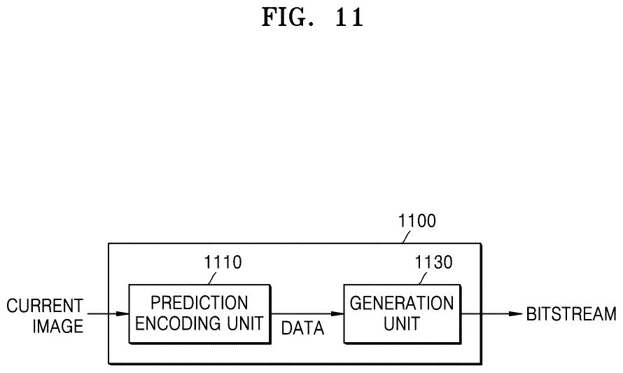

FIG. 11 is a diagram illustrating a configuration of an image encoding apparatus 1100 according to an embodiment.

Referring to FIG. 11, the image encoding apparatus 1100 may include a prediction encoding unit 1110 and a generation unit 1130.

The prediction encoding unit 1110 and the generation unit 1130 may be implemented by a processor. The prediction encoding unit 1110 and the generation unit 1130 may operate according to instructions stored in a memory.

Although FIG. 11 illustrates the prediction encoding unit 1110 and the generation unit 1130 separately, the prediction encoding unit 1110 and the generation unit 1130 may be implemented through one processor. In an embodiment, the prediction encoding unit 1110 and the generation unit 1130 may be implemented by a dedicated processor, or through a combination of general purpose processors, such as AP, CPU, or GPU, and software.

The prediction encoding unit 1110 and the generation unit 1130 may be configured by a plurality of processors. In an embodiment, the prediction encoding unit 1110 and the generation unit 1130 may be implemented by a combination of dedicated processors, or through a combination of general purpose processors, such as AP, CPU, or GPU, and software.

In an embodiment, the image encoding apparatus 1100 may use the first encoder 12, the first decoder 14, the second encoder 22, and the second decoder 24 for encoding the current image.

The first encoder 12, the first decoder 14, the second encoder 22, and the second decoder 24 may be stored in the memory. In an embodiment, the first encoder 12, the first decoder 14, the second encoder 22, and the second decoder 24 may be implemented by an AI processor.

The prediction encoding unit 1110 may encode the current image so as to generate data corresponding to a result of the encoding.

In an embodiment, at least one of the feature data of a preliminary optical flow, the feature data of a residual image, or the filtering information may be obtained as an encoding result for the current image.

In an embodiment, the prediction encoding unit 1110 may obtain feature data of a preliminary optical flow by applying the previous data and the current image to the first encoder 12.

The prediction encoding unit 1110 may obtain a preliminary optical flow for the current image by applying the feature data of the preliminary optical flow to the first decoder 14.

In an embodiment, the prediction encoding unit 1110 may apply quantization and inverse quantization to the feature data of a preliminary optical flow obtained from the first encoder 12, and apply the inversely quantized feature data of a preliminary optical flow to the first decoder 14. The reason for applying quantization and inverse quantization to the feature data of a preliminary optical flow is to obtain the same preliminary optical flow as the preliminary optical flow obtained by the image decoding apparatus 400.

In an embodiment, the prediction encoding unit 1110 may select a filter used for filtering a preliminary optical flow from among a plurality of filters. In an embodiment, the plurality of filters may include a Gaussian filter, a median filter, a Laplacian filter, or a neural network filter, but the type of a filter is not limited thereto.

The plurality of filters may be distinguished from each other according to the type and parameters. For example, a first filter may be a Gaussian filter and a second filter may be a median filter. Furthermore, for example, when the first filter and the second filter are Gaussian filters, the parameter values of the first filter and the parameter values of the second filter may be different from each other.

The prediction encoding unit 1110 may select a filter used for filtering a preliminary optical flow from among a plurality of filters specified by the type and/or parameter.

In an embodiment, the prediction encoding unit 1110 may select two or more filters for filtering a preliminary optical flow.

In an embodiment, filtering information for a filter selected for filtering a preliminary optical flow may be transmitted to the generation unit 1130.

In an embodiment, the prediction encoding unit 1110 may obtain an optical flow for the current block by filtering the preliminary optical flow using a filter selected from among a plurality of filters.

In an embodiment, the prediction encoding unit 1110 may obtain a filtered preliminary optical flow by filtering the preliminary optical flow with a filter. The prediction encoding unit 1110 may obtain an optical flow by calculating a weighted sum of the filtered preliminary optical flow and the preliminary optical flow according to the weight. In an embodiment, the weight used for the weighted sum may be selected from a plurality of candidate weights.

In an embodiment, the prediction encoding unit 1110 may obtain a first filtered preliminary optical flow by filtering the preliminary optical flow with a first filter selected from a plurality of filters, and obtain a second filtered preliminary optical flow by filtering the preliminary optical flow with a second filter selected from the plurality of filters. The prediction encoding unit 1110 may obtain an optical flow by calculating a weighted sum of the first filtered preliminary optical flow and the second filtered preliminary optical flow according to the weight.

In an embodiment, the prediction encoding unit 1110 may obtain the feature data of a residual image by using the optical flow and the previous data.

In an embodiment, the prediction encoding unit 1110 may generate a prediction image from the previous data based on the optical flow, and obtain a residual image corresponding to the difference between the prediction image and the current image. The prediction encoding unit 1110 may obtain the feature data of a residual image by applying the residual image to the second encoder 22.

In an embodiment, the prediction encoding unit 1110 may obtain the feature data of a residual image by applying the current image, the previous data, and the optical flow to the second encoder 22.

In an embodiment, the prediction encoding unit 1110 may obtain the prediction image generated from the previous data based on the optical flow, and obtain the feature data of a residual image by applying the current image to the second encoder 22.

In an embodiment, when the feature data of a residual image is obtained, the prediction encoding unit 1110 may generate a current reconstructed image by using the feature data of a residual image, the optical flow, the previous data, and the second decoder 24. As the method of generating the current reconstructed image is described in relation to the image decoding apparatus 400, a detailed description thereof is omitted. The current reconstructed image may be used for encoding the next image.

When data corresponding to a result of the encoding of the current image is obtained, the generation unit 1130 may generate a bitstream including the data.

In an embodiment, the generation unit 1130 may generate a first bitstream corresponding to the feature data of a preliminary optical flow and the filtering information, and a second bitstream corresponding to the feature data of a residual image.

The bitstream may be transmitted to the image decoding apparatus 400 through a network. In an embodiment, the bitstream may be recorded on a data storage medium including a magnetic medium such as a hard disk, a floppy disk, and a magnetic tape, an optical recording medium such as CD-ROM and DVD, or a magneto-optical medium such as a floptical disk.

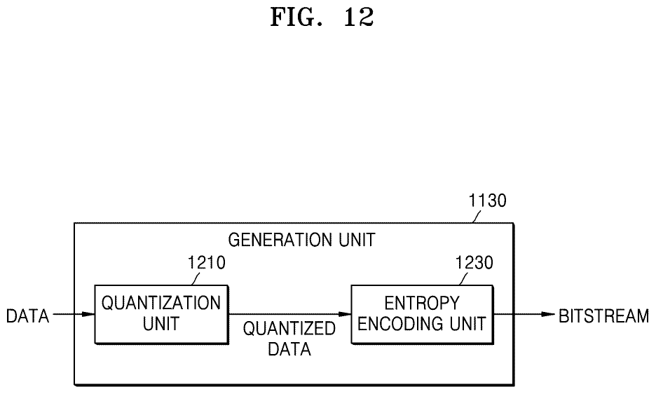

FIG. 12 is a diagram illustrating a configuration of the generation unit 1130 according to an embodiment.

Referring to FIG. 12, the generation unit 1130 may include a quantization unit 1210 and an entropy encoding unit 1230.

The quantization unit 1210 may quantize the data corresponding to the encoding result for the current image.

For example, the quantization unit 1210 may quantize the feature data of a preliminary optical flow and the feature data of a residual image. For example, quantization may be applied to the feature data of a preliminary optical flow and the feature data of a residual image, whereas quantization may not be applied to the filtering information. In this case, the quantized feature data of a preliminary optical flow, the quantized feature data of a residual image, and the filtering information may be transmitted to the entropy encoding unit 1230.

The entropy encoding unit 1230 may generate a bitstream by entropy coding the data transmitted from the quantization unit 1210.

In an embodiment, the generation unit 1130 may further include a transform unit. The transform unit may transform the data corresponding to the encoding result for the current image from a spatial domain to a frequency domain so as to provide the data to the quantization unit 1210.

In an embodiment, the generation unit 1130 may not include the quantization unit 1210. In other words, through the processing by the entropy encoding unit 1230, a bitstream including the data corresponding to the encoding result for the current image may be obtained.

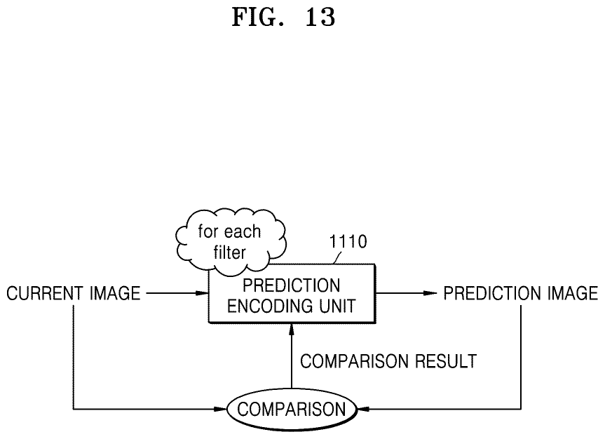

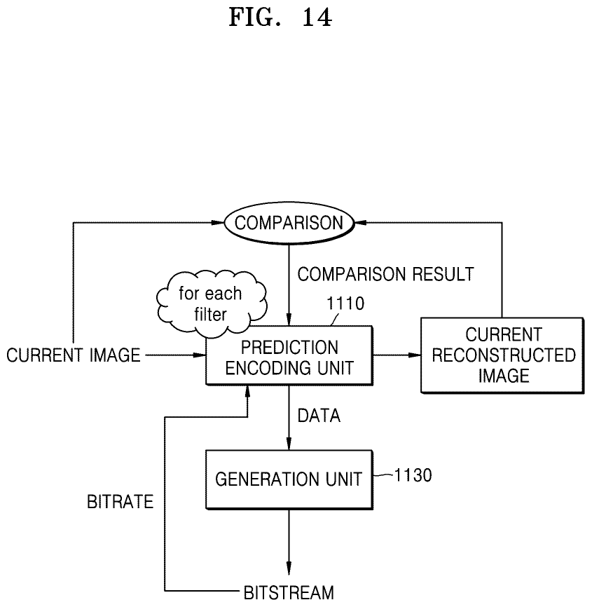

In the following description, a method of selecting a filter to be used for filtering a preliminary optical flow from among a plurality of filters (hereinafter, referred to as a plurality of candidate filters) is described with reference to FIGS. 13 and 14.

FIG. 13 is a diagram for explaining a method by which the prediction encoding unit 1110 selects a filter, according to an embodiment.

The prediction encoding unit 1110 may select one or more filters used for filtering of a preliminary optical flow from among the plurality of candidate filters.

In an embodiment, the prediction encoding unit 1110 may select a weight to be used for the weighted sum from among the plurality of candidate weights (e.g., 0, ⅛, ¼, ½, and 1). As described above, the weight may be used for the weighted sum between the filtered preliminary optical flow and the preliminary optical flow, or the weighted sum between two or more filtered preliminary optical flows. When the weighted sum is not used to obtain an optical flow, the prediction encoding unit 1110 may omit the weight selection process.

The plurality of candidate filters may be classified by the types and parameter values. The plurality of candidate filters may differ from each other in at least one of the types and the parameter values.

For example, the plurality of candidate filters may be the Gaussian filter, the median filter, the Laplacian filter, or the neural network filter which are illustrated in FIG. 6. For example, any one candidate filter may be a Gaussian filter having the size of 3, the x-axis direction standard deviation of 0, and the y-axis direction standard deviation of 0. Another candidate filter may be a Gaussian filter having the size of 3, the x-axis direction standard deviation of ½, and the y-axis direction standard deviation of 0. Another candidate filter may be a median filter having the size of 3.

Furthermore, for example, the plurality of candidate filters may correspond to the Gaussian filter, the median filter, the Laplacian filter, or the neural network filter which are illustrated in FIG. 6, and the strength of the plurality of candidate filters may be 3, 2, or 1.

The prediction encoding unit 1110 may apply each of the candidate filters and each of the candidate weights to a preliminary optical flow so as to select a filter and a weight that are the most suitable for filtering the preliminary optical flow.

Referring to FIG. 13, the prediction encoding unit 1110 may generate a prediction image from the current image by using each of the candidate filters and each of the candidate weights. The prediction encoding unit 1110 may select a filter and a weight for filtering a preliminary optical flow from among the plurality of candidate filters and the plurality of candidate weights based on a comparison result between the current image and the prediction image.

In an embodiment, the comparison result between the current image and the prediction image may include at least one of an L1-norm value, an L2-norm value, an SSIM value, a PSNR-HVS value, an MS-SSIM value, a VIF value, a VMAF value, an MSE value, an RMSE value, or an SAD value between the current image and the prediction image.

A process of calculating the comparison result between the current image and the prediction image by using any one candidate filter and any one candidate weight is described.

The prediction encoding unit 1110 may obtain a preliminary optical flow from the current image and the previous data. The first encoder 12 and the first decoder 14 may be used to obtain the preliminary optical flow.

The prediction encoding unit 1110 may generate a filtered preliminary optical flow by filtering the preliminary optical flow with a candidate filter. The prediction encoding unit 1110 may obtain an optical flow by calculating a weighted sum of the preliminary optical flow and the filtered preliminary optical flow according to the candidate weight.

The prediction encoding unit 1110 may generate a prediction image by using the optical flow and the previous data. Warping may be applied to the previous data to obtain the prediction image. When the prediction image is generated, the prediction encoding unit 1110 may calculate a comparison result between the current image and the prediction image, and select a filter and a weight for filtering a preliminary optical flow by using the calculated comparison result.

In an embodiment, the prediction encoding unit 1110 may select a filter and a weight used for generating a prediction image that is most similar to the current image from among the plurality of candidate filters and the plurality of candidate weights.

The filter and weight selection process may be expressed in the psuedo code in Table 1.

TABLE 1

```
Best Distance = Infinity
for each Filter type in Type List {
  for each Size in Size List {
    for each Parameter in Parameter List (
      for each Weight in Weight List {
        Distance = Distance (Predicted image, Current image)
        if Best Distance > Distance {
        Best Distance = Distance
        Best Filter type = Filter type in Type List
        Best Size = Size in Size List
        Best Parameter = Parameter in Parameter List
        Best Weight = Weight in Weight List
}
}
}
}
}
```

In Table 1, the distance may correspond to the comparison result between the current image and the prediction image. Referring to Table 1, the first Best distance may be set to infinity. A comparison result (distance) between the prediction image and the current image may be calculated for each filter type in a type list, each size in a size list, each parameter in a parameter list, and each weight in a weight list. When the distance is less than the Best distance, the distance may be determined to be a new Best distance, and the type, size, parameter, and weight corresponding to the Best distance may be determined to be the best type, the best size, the best parameter, and the best weight, respectively. The best type, the best size, the best parameter, and the best weight, which are lastly determined, may be used for filtering a preliminary optical flow.

FIG. 14 is a diagram for explaining a method in which the prediction encoding unit 1110 selects a filter, according to an embodiment

In an embodiment, the prediction encoding unit 1110 may select a filter and a weight used to generate a current reconstructed image that is most similar to the current image from among the plurality of candidate filters and the plurality of candidate weights.

In an embodiment, the comparison result between the current image and the current reconstructed image may include at least one of an L1-norm value, an L2-norm value, an SSIM value, a PSNR-HVS value, an MS-SSIM value, a VIF value, a VMAF value, an MSE value, an RMSE value, or an SAD value between the current image and the current reconstructed image.

In an embodiment, the prediction encoding unit 1110 may further consider the bitrate of a bitstream in selecting a filter and a weight.

Referring to FIG. 14, the prediction encoding unit 1110 may encode the current image based on each of the candidate filters and each of the candidate weights, and transmit data generated as a result of the encoding to the generation unit 1130.

In an embodiment, the prediction encoding unit 1110 may transmit the feature data of a preliminary optical flow, the feature data of a residual image, and the filtering information indicating the candidate filter and the candidate weight, as the encoding result for the current image, to the generation unit 1130.

The generation unit 1130 may generate a bitstream based on the transmitted data.

In an embodiment, the prediction encoding unit 1110 may select a filter and a weight based on the bitrate of a bitstream corresponding to the feature data of a preliminary optical flow, the feature data of a residual image, and the filtering information.

In an embodiment, the bitrate of a bitstream corresponding to the feature data of a preliminary optical flow, the feature data of a residual image, and the filtering information may be a bitrate of a result of entropy encoding the feature data of a preliminary optical flow, the feature data of a residual image, and the filtering information.

For example, the prediction encoding unit 1110 may select a filter and a weight that cause the smallest rate, from among the plurality of candidate filters and the plurality of candidate weights.

In an embodiment, the prediction encoding unit 1110 may select a filter and a weight used for filtering a preliminary optical flow from among the plurality of candidate filters and the plurality of candidate weights, based on the comparison result between the current image, the current reconstructed image, and the bitrate of a bitstream.

For example, the prediction encoding unit 1110 may calculate a loss value by calculating a weighted sum of a value corresponding to the comparison result between the current image and the current reconstructed image and a value corresponding to the bitrate of a bitstream, and select a filter and a weight which cause the smallest loss value.

A process of calculating a loss value by using any one candidate filter and any one candidate weight is described.

The prediction encoding unit 1110 may obtain a preliminary optical flow from the current image and the previous data. The first encoder 12 and the first decoder 14 may be used to obtain a preliminary optical flow.

The prediction encoding unit 1110 may generate a filtered preliminary optical flow by filtering the preliminary optical flow by using any one candidate filter. The prediction encoding unit 1110 may obtain an optical flow by calculating a weighted sum of the preliminary optical flow and the filtered preliminary optical flow according to a candidate weight.

The prediction encoding unit 1110 may generate a current reconstructed image by using the optical flow and the previous data. The second encoder 22 and the second decoder 24 may be used to generate the current reconstructed image.

When the current reconstructed image is generated, a comparison result between the current image and the current reconstructed image may be calculated. Furthermore, the bitrate of a bitstream may be calculated by using the feature data of a preliminary optical flow output from the first encoder 12, the feature data of a residual image output from the second encoder 22, and the filtering information indicating any one candidate filter and any one candidate weight. The prediction encoding unit 1110 may calculate a loss value corresponding to any one candidate filter and any one candidate weight from the comparison result between the current image and the current reconstructed image, and the bitrate of a bitstream.

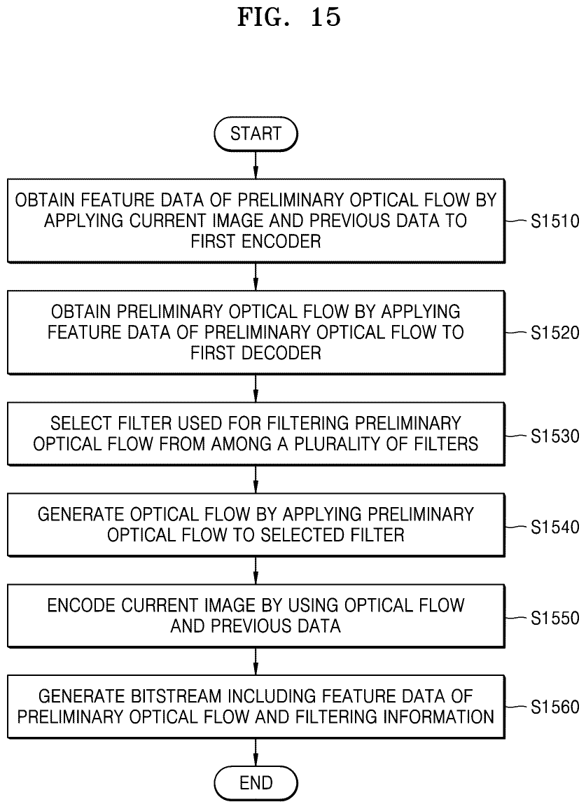

FIG. 15 is a flowchart of an image encoding method according to an embodiment.

In operation S1510, the image encoding apparatus 1100 may obtain feature data of a preliminary optical flow by applying the current image and the previous data to the first encoder 12.

In operation S1520, the image encoding apparatus 1100 may obtain a preliminary optical flow by applying the feature data of the preliminary optical flow to the first decoder 14.

In operation S1530, the image encoding apparatus 1100 may select a filter used for filtering a preliminary optical flow from among a plurality of filters.

As the filter selection method is already described above with reference to FIGS. 13 and 14, a detailed description thereof is omitted.

In operation S1540, the image encoding apparatus 1100 may generate an optical flow by applying the preliminary optical flow to a selected filter.

In an embodiment, the image encoding apparatus 1100 may obtain a filtered preliminary optical flow by applying a preliminary optical flow to a filter, and obtain an optical flow by calculating a weighted sum of the filtered preliminary optical flow and the preliminary optical flow.

In an embodiment, the image encoding apparatus 1100 may obtain a first filtered preliminary optical flow by applying a preliminary optical flow to a first filter, and obtain a second filtered preliminary optical flow by applying a preliminary optical flow to a second filter. The image encoding apparatus 1100 may obtain an optical flow by calculating a weighted sum of the first filtered preliminary optical flow and the second filtered preliminary optical flow.

In operation S1550, the image encoding apparatus 1100 may encode the current image by using the optical flow and the previous data.

In an embodiment, the feature data of a residual image may be obtained as an encoding result for the current image.

In an embodiment, the image encoding apparatus 1100 may generate a prediction image from the previous data based on the optical flow, and obtain a residual image corresponding to the difference between the prediction image and the current image. The image encoding apparatus 1100 may obtain the feature data of a residual image by applying the residual image to the second encoder 22.

In an embodiment, the image encoding apparatus 1100 may obtain the feature data of a residual image by applying the current image, the previous data, and the optical flow to the second encoder 22.

In an embodiment, the image encoding apparatus 1100 may obtain the feature data of a residual image by applying the prediction image generated from the previous data based on the optical flow, and the current image, to the second encoder 22.

In operation S1560, the image encoding apparatus 1100 may generate a bitstream including the feature data of a preliminary optical flow and the filtering information.

In an embodiment, the filtering information may include at least one of type information of a filter, parameter information, or weight information.

In an embodiment, the bitstream may further include the feature data of a residual image.

As described above, when a neural network filter is used for filtering a preliminary optical flow, the image encoding apparatus 1100 and the image decoding apparatus 400 may apply the preliminary optical flow to a neural network selected from among a plurality of neural networks.

While each of the neural networks may process the preliminary optical flow according to the parameters set through training, a method of training a neural network used as a neural network filter is described with reference to FIG. 16.

FIG. 16 is a diagram illustrating a method of training a neural network that may be used for a neural network filter, according to an embodiment.

Referring to FIG. 16, a neural network 1600 may receive an input of a preliminary optical flow for training, and output an optical flow for training by processing the preliminary optical flow for training according to preset parameters.

A comparison result between a ground truth optical flow and the optical flow for training may be used, as loss information, for training the neural network 1600. In an embodiment, the comparison result between the ground truth optical flow and the optical flow for training may include an L1-norm value, an L2-norm value, an SSIM value, a PSNR-HVS value, an MS-SSIM value, a VIF value, a VMAF value, an MSE value, an RMSE value, or an SAD value.

The neural network 1600 may update parameters so that loss information is reduced or minimized, and process the preliminary optical flow for training, which is input next, by using the updated parameters. When the optimization of the parameters of the neural network 1600 is completed, the corresponding neural network 1600 may be stored in the image encoding apparatus 1100 and the image decoding apparatus 400.

In an embodiment, a plurality of neural networks to be used as a neural network filter may have different internal structures from each other, and accordingly the filtering strengths thereof may differ from each other. For example, the filtering strength of a neural network having n convolution layers (n is an integer of 2 or more) may be stronger than the filtering strength of a neural network having m convolution layers (m is an integer less than n). As each of the plurality of neural networks having different internal structures is trained based on the preliminary optical flow for training, a plurality of neural networks having different filtering strengths may be used as neural network filters.

In an embodiment, a plurality of neural networks used in neural network filters may be trained based on different types of preliminary optical flows for training. Accordingly, a plurality of neural networks having different filtering strengths from each other may be obtained.

For example, the filtering strength of a neural network trained based on a high-quality preliminary optical flow for training may be relatively low, and the filtering strength of a neural network trained based on a low-quality preliminary optical flow for training may be relatively strong.

A method of training the neural network 1600 by using different types of preliminary optical flows for training is described.

In an embodiment, a first ground truth optical flow may be obtained from a previous reconstructed image (or previous data) reconstructed based on first quantization parameters, and the current image. The first ground truth optical flow may be extracted according to a predetermined optical flow extraction method (e.g., Flownet, OpenCV optical flow estimation, etc.). The previous data and the current image may be sequentially applied to the first encoder 12 and the first decoder 14, and the first preliminary optical flow for training may be output from the first decoder 14. The first preliminary optical flow for training may be processed by the neural network 1600, and the neural network 1600 may be trained based on the comparison result between the first optical flow for training output from the neural network 1600 and the first ground truth optical flow.

Next, a second ground truth optical flow may be obtained from the previous reconstructed image (or the previous data) reconstructed based on second quantization parameters, and the current image. The previous data and the current image may be sequentially applied to the first encoder 12 and the first decoder 14, and a second preliminary optical flow for training may be output from the first decoder 14. The second preliminary optical flow for training may be processed by the neural network 1600, and the neural network 1600 may be trained based on the comparison result between the second optical flow for training output from the neural network 1600 and the second ground truth optical flow.

In an embodiment, when a size of the first quantization parameter is smaller than a size of the second quantization parameter, the quality of the first preliminary optical flow for training may be greater than the quality of the second preliminary optical flow for training. This is because the quality of a previous reconstructed image reconstructed according to high quantization parameters is relatively low, and thus the quality of a preliminary optical flow for training obtained based on the low-quality previous reconstructed image may also be low. In other words, the strength of the neural network 1600 that is trained based on the high-quality first preliminary optical flow for training may be lower than the strength of a neural network trained based on the low-quality second preliminary optical flow for training.

In an embodiment, a plurality of neural networks having different filtering strengths may be obtained by varying the quantization parameters used to obtain the previous reconstructed image (or the previous data).

In an embodiment, the preliminary optical flow for training may be obtained by changing the sample values of the ground truth optical flow. The quality of a preliminary optical flow for training may be determined depending on the degree of change in the sample values of the ground truth optical flow.

In an embodiment, the training of a plurality of neural networks to be used for neural network filters may be performed by the image encoding apparatus 1100, and a plurality of neural networks that have completed training may be transmitted to the image decoding apparatus 400.

In an embodiment, a plurality of neural networks may be trained by a separate training apparatus (e.g., a server), and a plurality of neural networks that have completed training may be transmitted to the image encoding apparatus 1100 and the image decoding apparatus 400.

In the following description, a method of training the first encoder 12, the first decoder 14, the second encoder 22, and the second decoder 24 is described with reference to FIGS. 17 and 18.

FIG. 17 is a diagram illustrating a method of training the first encoder 12, the first decoder 14, the second encoder 22, and the second decoder 24, according to an embodiment.

In FIG. 17, a current image for training 1710, previous data for training 1720, and a current reconstructed image for training 1780 may correspond to the current image, the previous data, and the current reconstructed image described above, respectively.

In training the first encoder 12, the first decoder 14, the second encoder 22, and the second decoder 24, it may be considered how similar the current reconstructed image for training 1780 is to the current image for training 1710, and how large the bitrate of a bitstream generated through encoding the current image for training 1710 is. To this end, in an embodiment, the first encoder 12, the first decoder 14, the second encoder 22, and the second decoder 24 may be trained according to first loss information 1792 and second loss information 1794 that correspond to the size of the bitstream, and third loss information 1796 that corresponds to the similarity between the current image for training 1710 and the current reconstructed image for training 1780.

Referring to FIG. 17, the current image for training 1710 and the previous data for training 1720 may be input to the first encoder 12. The first encoder 12 may output the feature data w of a preliminary optical flow by processing the current image for training 1710 and the previous data for training 1720.

The feature data w of a preliminary optical flow may be input to the first decoder 14, and the first decoder 14 may output the preliminary optical flow g by processing the feature data w of a preliminary optical flow.

As the previous data for training 1720 is warped 40 according to the preliminary optical flow g, a prediction image for training 1750 may be generated, and a residual image for training 1760 corresponding to the difference between the prediction image for training 1750 and the current image for training 1710 may be obtained.

The residual image for training 1760 may be input to the second encoder 22, and the second encoder 22 may output the feature data v of the residual image by processing the residual image for training 1760.

The second decoder 24 may reconstruct the residual image for training 1760 by processing the feature data v of the residual image, and as a reconstructed residual image for training 1770 and the prediction image for training 1750 are combined with each other, the current reconstructed image for training 1780 may be obtained.

For training of the first encoder 12, the first decoder 14, the second encoder 22, and the second decoder 24, at least one of the first loss information 1792, the second loss information 1794, or the third loss information 1796 may be obtained.

The first loss information 1792 may correspond to the entropy of the feature data w of a preliminary optical flow or the bitrate of a bitstream corresponding to the feature data w of the preliminary optical flow. Furthermore, the second loss information 1794 may correspond to the entropy of the feature data v of the residual image or the bitrate of a bitstream corresponding to the feature data v of the residual image.

In an embodiment, one loss information may be calculated from the bitrate of a bitstream corresponding to feature data w of a preliminary optical flow and the feature data v of the residual image, instead of the first loss information 1792 and the second loss information 1794.

As the first loss information 1792 and the second loss information 1794 are related to the encoding efficiency of the current image for training 1710, compression may also be referred to as loss information.

The third loss information 1796 may correspond to the difference between the current image for training 1710 and the current reconstructed image for training 1780. The difference between the current image for training 1710 and the current reconstructed image for training 1780 may include at least one of an L1-norm value, an L2-norm value, a structural similarity (SSIM) value, a peak signal-to-noise ratio-human vision system (PSNR-HVS) value, a multiscale SSIM (MS-SSIM) value, a variance inflation factor (VIF) value, or a video multimethod assessment fusion (VMAF) value between the current image for training 1710 and the current reconstructed image for training 1780.

The third loss information 1796, which is related to the quality of the current reconstructed image for training 1780, may be referred to as quality loss information.

The first encoder 12, the first decoder 14, the second encoder 22, and the second decoder 24 may be trained such that the final loss information derived from at least one of the first loss information 1792, the second loss information 1794, or the third loss information 1796 is reduced or minimized.

In an embodiment, the first encoder 12, the first decoder 14, the second encoder 22, and the second decoder 24 can operate to reduce or minimize the final loss information by changing the values of parameters set in advance.

In an embodiment, the final loss information may be calculated according to Equation 3 below.

$$Final Loss Information = a * First Loss Information + b * Second Loss Information + c * Third Loss Information \qquad [ Equation 3 ]$$

In Equation 3, a, b, and c may each be a weight applied to each of the first loss information 1792, the second loss information 1794, and the third loss information 1796.

According to Equation 3, it may be seen that the first encoder 12, the first decoder 14, the second encoder 22, and the second decoder 24 are trained in the direction in which the current reconstructed image for training 1780 becomes maximally similar to the current image for training 1710, and the size of the bitstream corresponding to the data output from the first encoder 12 and the second encoder 22 is minimized.

FIG. 18 is a diagram illustrating a method of training the first encoder 12, the first decoder 14, the second encoder 22, and the second decoder 24, according to an embodiment.

Referring to FIG. 18, the current image for training 1710 and the previous data for training 1720 may be input to the first encoder 12. The first encoder 12 may output the feature data w of a preliminary optical flow by processing the current image for training 1710 and the previous data for training 1720.

The feature data w of a preliminary optical flow may be input to the first decoder 14, and the first decoder 14 may output the preliminary optical flow g by processing the feature data w of a preliminary optical flow.

The preliminary optical flow g, the current image for training 1710, and the previous data for training 1720 may be input to the second encoder 22, and the second encoder 22 may be output the feature data v of the residual image by processing the preliminary optical flow g, the current image for training 1710, and the previous data for training 1720. In an embodiment, a prediction image for training generated from the preliminary optical flow g and the previous data for training 1720, and the current image for training 1710, may be input to the second encoder 22.

The second decoder 24 may generate the current reconstructed image for training 1780 by processing the feature data v of the residual image, the preliminary optical flow g, and the previous data for training 1720. In an embodiment, a prediction image for training generated from the preliminary optical flow g and the previous data for training 1720, and the feature data v of the residual image, may be input to the second decoder 24.

For training of the first encoder 12, the first decoder 14, the second encoder 22, and the second decoder 24, at least one of first loss information 1892, second loss information 1894, or third loss information 1896 may be obtained.

The first loss information 1892 may correspond to the entropy of the feature data w of a preliminary optical flow or the bitrate of a bitstream corresponding to the feature data w of the preliminary optical flow. Furthermore, the second loss information 1894 may correspond to the entropy of the feature data v of the residual image or the bitrate of a bitstream corresponding to the feature data v of the residual image.

In an embodiment, one loss information may be calculated from the bitrate of a bitstream corresponding to the feature data w of a preliminary optical flow and the feature data v of the residual image, instead of the first loss information 1892 and the second loss information 1894.

The third loss information 1896 may correspond to the difference between the current image for training 1710 and the current reconstructed image for training 1780. The difference between the current image for training 1710 and the current reconstructed image for training 1780 may include at least one of an L1-norm value, an L2-norm value, a structural similarity (SSIM) value, a peak signal-to-noise ratio-human vision system (PSNR-HVS) value, a multiscale SSIM (MS-SSIM) value, a variance inflation factor (VIF) value, or a video multimethod assessment fusion (VMAF) value between the current image for training 1710 and the current reconstructed image for training 1780

The first encoder 12, the first decoder 14, the second encoder 22, and the second decoder 24 may be trained such that final loss information derived from at least one of the first loss information 1892, the second loss information 1894, or the third loss information 1896 is reduced or minimized.

In an embodiment, the first encoder 12, the first decoder 14, the second encoder 22, and the second decoder 24 may operate to reduce or minimize the final loss information while changing the values of parameters that are set in advance.

In an embodiment, the final loss information may be calculated according to Equation 3 described above.

Th process of training the first encoder 12, the first decoder 14, the second encoder 22, and the second decoder 24, which is described with reference to FIGS. 17 and 18, may be performed by the image encoding apparatus 1100. The first encoder 12, the first decoder 14, the second encoder 22, and the second decoder 24 that have completed training may be transmitted to the image decoding apparatus 400.

In an embodiment, the process of training the first encoder 12, the first decoder 14, the second encoder 22, and the second decoder 24 may be performed by a separate training apparatus (e.g., a server). The first encoder 12, the first decoder 14, the second encoder 22, and the second decoder 24 that have completed training may be transmitted to the image decoding apparatus 400 and the image encoding apparatus 1100.

An embodiment is directed to reducing a bitrate of a bitstream resulting from image encoding.

An embodiment is directed to improving the quality of a reconstructed image generated through decoding of a bitstream.

An embodiment is directed to providing an AI-based end-to-end encoding/decoding system.

The technical problems to be achieved by the present disclosure are not limited to the technical problems described above, and other technical problems not explicitly described will be clearly understood by those having ordinary skill in the art to which the present disclosure pertains from the following description.

An image decoding method according to an embodiment may include obtaining feature data of a preliminary optical flow and filtering information from a bitstream.

In an embodiment, the filtering information may include at least one of type information of a filter or parameter information of a filter.

An image decoding method according to an embodiment may include obtaining a preliminary optical flow by applying the feature data of the preliminary optical flow to the neural network based first decoder 14.

An image decoding method according to an embodiment may include generating an optical flow by applying the preliminary optical flow to a filter corresponding to the filtering information.

An image decoding method according to an embodiment may include generating a current reconstructed image by using previous data and the optical flow.

According to an image decoding method according to an embodiment, as the quality of the optical flow is improved, the quality of a current reconstructed image may also be improved.

In an embodiment, the image decoding method may further include obtaining the feature data of a residual image from a bitstream, and the generating of a current reconstructed image may include obtaining a current reconstructed image by applying the optical flow, the feature data of a residual image, and the previous data to the neural network based second decoder 24.

According to an embodiment, the current reconstructed image may be more accurately reconstructed based on the neural network.

In an embodiment, the image decoding method may further include: obtaining the feature data of a residual image from a bitstream, and the generating of a current reconstructed image may include obtaining a residual image by applying the feature data of a residual image to the neural network based second decoder 24; generating a prediction image from the previous data based on the optical flow; and generating a current reconstructed image by combining the prediction image and the residual image.

According to an embodiment, the current reconstructed image may be more accurately reconstructed based on the neural network.

In an embodiment, the filtering information may further include: weight information, and the generating of the optical flow may include generating a filtered preliminary optical flow by applying the preliminary optical flow to a filter corresponding to the filtering information; and generating an optical flow by combining the preliminary optical flow and the filtered preliminary optical flow according to the weight information.

According to an embodiment, the optical flow may be more accurately generated based on the weight information.

In an embodiment, the filtering information may further include: weight information, and the generating of the optical flow may include generating a first filtered preliminary optical flow by applying the preliminary optical flow to a first filter indicated by the type information; generating a second filtered preliminary optical flow by applying the preliminary optical flow to a second filter indicated by the type information; and generating an optical flow by combining the first filtered preliminary optical flow and the second filtered preliminary optical flow according to the weight information.

According to an embodiment, the optical flow may be more accurately generated based on the weight information.

In an embodiment, the type information of a filter may indicate at least one of at least one of a Gaussian filter, a median filter, a bilateral filter, or a neural network filter.

According to an embodiment, as a filter suitable for filtering the preliminary optical flow is selected from among the plurality of filters, a more accurate optical flow may be generated.

In an embodiment, when the type information of a filter indicates a neural network filter, the parameter information indicates any one neural network among a plurality of neural networks of different types, and the generating of the optical flow may include obtaining an optical flow by applying the preliminary optical flow to a neural network indicated by the parameter information.

According to an embodiment, as the preliminary optical flow is filtered based on the neural network, a more accurate optical flow may be generated.

According to an embodiment, the image encoding method may include obtaining the feature data of a preliminary optical flow by applying the current image and the previous data to the neural network based first encoder 12.

According to an embodiment, the image encoding method may include obtaining a preliminary optical flow by applying the feature data of the preliminary optical flow to the neural network based first decoder 14.

According to an embodiment, the image encoding method may include selecting a filter used for filtering the preliminary optical flow from among a plurality of filters.

According to an embodiment, the image encoding method may include generating an optical flow by applying the preliminary optical flow to a selected filter.

According to an embodiment, the image encoding method may include encoding a current image by using the optical flow and the previous data.

According to an embodiment, the image encoding method may include generating a bitstream including the feature data of the preliminary optical flow and filtering information for the filter.

In an embodiment, the filtering information may include at least one of type information of a filter or parameter information of a filter.

According to the image encoding method according to an embodiment, as the quality of an optical flow is improved, the bitrate of a bitstream may be reduced.

In an embodiment, the encoding of the current image may include obtaining the feature data of a residual image by applying the current image, the previous data, and the optical flow to the neural network based second encoder 22, and the feature data of the residual image may be included in the bitstream.

According to an embodiment, the current image may be more effectively encoded based on the neural network.

In an embodiment, the encoding of the current image may include: generating a prediction image from the previous data based on the optical flow; and obtaining the feature data of a residual image by applying the residual image corresponding to the difference between the prediction image and the current image to the neural network based second encoder 22, and the feature data of the residual image may be included in the bitstream.

According to an embodiment, the current image may be more effectively encoded based on the neural network.

In an embodiment, the selecting of the filter may include: generating a plurality of optical flows by applying the preliminary optical flow to a plurality of filters; and selecting at least one filter from among the plurality of filters based on the difference between the current image and each of a plurality of prediction images generated based on each of the plurality of optical flows.

According to an embodiment, as a filter suitable for filtering the preliminary optical flow is selected from among the plurality of filters, a more accurate optical flow may be generated.

In an embodiment, the selecting of the filter may include selecting at least one filter from among the plurality of filters based on at least one of the difference between the current image and each of a plurality of current reconstructed images which are generated in response to each of the plurality of filters, or a comparison result of bitrates of bitstreams which are generated respectively in response to each of the plurality of filters.

According to an embodiment, as a filter suitable for filtering the preliminary optical flow is selected from among the plurality of filters, a more accurate optical flow may be generated.

In an embodiment, the plurality of filters include neural network filters that use different types of neural networks, the neural networks used in the neural network filters may output an optical flow for training by processing a preliminary optical flow for training, and the neural networks may be trained based on a comparison result between the optical flow for training and a ground truth optical flow.

According to an embodiment, the neural network may be trained so as to generate an accurate optical flow.

A computer-readable recording medium according to an embodiment may record a bitstream.

In an embodiment, the bitstream may include the feature data of a preliminary optical flow and the filtering information.

In an embodiment, the feature data of a preliminary optical flow may be obtained by applying the current image and the previous data to the neural network based first encoder 12.

In an embodiment, the filtering information may be obtained by applying the feature data of the preliminary optical flow to the neural network based first decoder 14 to obtain the preliminary optical flow, and by selecting a filter used for filtering the preliminary optical flow from among the plurality of filters.

In an embodiment, as the preliminary optical flow is applied to the selected filter, the optical flow may be generated, and the current image may be encoded by using the optical flow and the previous data.

In an embodiment, the filtering information may include at least one of type information of a filter or parameter information of a filter.

An image decoding apparatus according to an embodiment may include the obtaining unit 410 that obtains the feature data of the preliminary optical flow and the filtering information from the bitstream.

In an embodiment, the filtering information may include at least one of type information of a filter or parameter information of a filter.

An image decoding apparatus according to an embodiment may include the prediction decoding unit 430 that obtains the preliminary optical flow by applying the feature data of the preliminary optical flow to the neural network based first decoder 14, generate an optical flow by applying the preliminary optical flow to a filter corresponding to the filtering information, and generate a current reconstructed image by using previous data and the optical flow.

According to the image decoding apparatus according to an embodiment, as the quality of the optical flow is improved, the quality of a current reconstructed image may also be improved.

An image encoding apparatus according to an embodiment may include the prediction encoding unit 1110 that obtains the feature data of a preliminary optical flow by applying the current image and the previous data to the neural network based first encoder 12, obtains the preliminary optical flow by applying the feature data of the preliminary optical flow to the neural network based first decoder 14, selects a filter used for filtering the preliminary optical flow from among a plurality of filters, generates an optical flow by applying the preliminary optical flow to a selected filter, and encode the current image by using the optical flow and the previous data.

An image encoding apparatus according to an embodiment may include the generation unit 1130 that generates a bitstream including the feature data of the preliminary optical flow and filtering information for the filter.

In an embodiment, the filtering information may include at least one of type information of a filter or parameter information of a filter.

According to the image encoding apparatus according to an embodiment, as the quality of an optical flow is improved, the bitrate of a bitstream may be reduced.

In an embodiment, the bitrate of a bitstream generated as a result of encoding an image may be reduced.

In an embodiment, the quality of a reconstructed image generated through the decoding of the bitstream may be improved.

In an embodiment, an AI-based end-to-end encoding/decoding system may be provided.

The effects of the present disclosure are not limited to the above-described effects, and other various effects that are not described in the present disclosure may be clearly understood from the following descriptions by one skilled in the art to which the present disclosure belongs.

The embodiments of the present disclosure may be written as a program to be executed on a computer, and the written programs may be stored in a machine-readable recording medium.

The machine-readable storage medium may be provided in the form of a non-transitory storage medium. Here, “non-transitory” merely means that the storage media do not contain signals (e.g., electromagnetic waves) and are tangible, but do not distinguish data being semi-permanently or temporarily stored in the storage media. For example, a non-transitory storage medium may include a buffer in which data is temporarily stored.

According to an embodiment, the method disclosed according to various embodiment of the present disclosure may be provided by being included in a computer program product. A computer program product as goods may be dealt between a seller and a buyer. A computer program product may be distributed (e.g., download or upload) in the form of a device-readable storage medium (e.g., a compact disc read only memory (CD-ROM)), or through an application store or directly online between two user devices (e.g., smartphones). For online distribution, at least part of a computer program product (e.g., a downloadable application) may be at least temporarily stored or generated on a device-readable storage medium such as a manufacturer's server, a server of the application store, or a memory of a relay server.

As described above, while this disclosure has been particularly shown and described with reference to preferred embodiments thereof, it will be understood by those of ordinary skill in the art that various changes in form and details may be made therein without departing from the spirit and scope of the present disclosure as defined by the appended claims.

What is claimed is:

1. An image decoding method comprising:
obtaining, from a bitstream, feature data of a preliminary optical flow and filtering information, the filtering information comprising at least one of type information of a filter or parameter information of a filter;
obtaining the preliminary optical flow by applying the feature data of the preliminary optical flow to a neural network based first decoder;
generating an optical flow by applying the preliminary optical flow to a filter corresponding to the filtering information; and
generating a current reconstructed image by using previous data and the optical flow.

2. The image decoding method of claim 1, wherein
the image decoding method further comprises obtaining feature data of a residual image from the bitstream, and
the generating of the current reconstructed image comprises obtaining the current reconstructed image by applying the optical flow, the feature data of the residual image, and the previous data to a neural network based second decoder.

3. The image decoding method of claim 1, further comprising:
obtaining feature data of a residual image from the bitstream,
wherein the generating of the current reconstructed image comprises:
obtaining the residual image by applying the feature data of the residual image to a neural network based second decoder;
generating a prediction image from the previous data based on the optical flow; and
generating the current reconstructed image by combining the prediction image and the residual image.

4. The image decoding method of claim 1, wherein
the filtering information further comprises weight information, and
the generating of the optical flow comprises:
generating a filtered preliminary optical flow by applying the preliminary optical flow to a filter corresponding to the filtering information; and
generating the optical flow by combining the preliminary optical flow and the filtered preliminary optical flow according to the weight information.

5. The image decoding method of claim 1, wherein
the filtering information further comprises weight information, and
the generating of the optical flow comprises:
generating a first filtered preliminary optical flow by applying the preliminary optical flow to a first filter indicated by the type information;
generating a second filtered preliminary optical flow by applying the preliminary optical flow to a second filter indicated by the type information; and
generating the optical flow by combining the first filtered preliminary optical flow and the second filtered preliminary optical flow according to the weight information.

6. The image decoding method of claim 1, wherein
the type information of the filter indicates at least one of a Gaussian filter, a median filter, a bilateral filter, or a neural network filter.

7. The image decoding method of claim 1, wherein
when the type information of the filter indicates the neural network filter, the parameter information indicates a neural network among a plurality of neural networks of different types, and
the generating of the optical flow comprises:
obtaining the optical flow by applying the preliminary optical flow to the neural network indicated by the parameter information.

8. An image encoding method comprising:
obtaining feature data of a preliminary optical flow by applying a current image and previous data to a neural network based first encoder;
obtaining the preliminary optical flow by applying the feature data of the preliminary optical flow to a neural network based first decoder;
selecting a filter used for filtering the preliminary optical flow from among a plurality of filters;
generating an optical flow by applying the preliminary optical flow to the filter;
encoding the current image by using the optical flow and the previous data; and
generating a bitstream comprising the feature data of the preliminary optical flow and filtering information for the filter,
wherein the filtering information comprises at least one of type information of the filter or parameter information of the filter.

9. The image encoding method of claim 8, wherein the encoding of the current image comprises:
obtaining feature data of a residual image by applying the current image, the previous data, and the optical flow to a neural network based second encoder, wherein
the feature data of the residual image is included in the bitstream.

10. The image encoding method of claim 8, wherein the encoding of the current image comprises:
generating a prediction image from the previous data based on the optical flow; and
obtaining the feature data of the residual image by applying the residual image corresponding to a difference between the prediction image and the current image to the neural network based second encoder, wherein
the feature data of the residual image is included in the bitstream.

11. The image encoding method of claim 8, wherein the selecting of the filter comprises:
generating a plurality of optical flows by applying the preliminary optical flow to the plurality of filters; and
selecting at least one filter from among the plurality of filters based on a difference between each of a plurality of prediction images generated based on each of the plurality of optical flows and the current image.

12. The image encoding method of claim 8, wherein the selecting of the filter comprises:
selecting at least one filter from among the plurality of filters based on at least one of:
a difference between each of a plurality of current reconstructed images which are generated in response to each of the plurality of filters and the current image, or
a comparison result of bitrates of bitstreams which are generated in response to each of the plurality of filters.

13. The image encoding method of claim 8, wherein the plurality of filters comprise neural network filters that use different types of neural networks,
the neural networks used in the neural network filters output a training optical flow by processing a training preliminary optical flow, and
the neural networks are trained based on a comparison result between the training optical flow and a ground truth optical flow.

14. A non-transitory computer-readable recording medium having recorded thereon instructions executable by at least one processor to cause the at least one processor to perform a method comprising:
obtaining feature data of a preliminary optical flow by applying a current image and previous data to a neural network based first encoder;
obtaining the preliminary optical flow by applying the feature data of the preliminary optical flow to a neural network based first decoder;
selecting a filter used for filtering the preliminary optical flow from among a plurality of filters;
generating an optical flow by applying the preliminary optical flow to the filter;
encoding the current image by using the optical flow and the previous data; and
generating a bitstream comprising the feature data of the preliminary optical flow and filtering information for the filter,
wherein the filtering information comprises at least one of type information of the filter or parameter information of the filter.
